(19) United States
(12) Patent Application Publication
(10) Pub. No.: US 2021/0392833 A1
(43) Pub. Date: Dec. 23, 2021

(54) CONTAINER GARDENING STRUCTURES AND MANAGEMENT THEREOF

(71) Applicant: SynchroSystems, Inc., Cambridge, MA (US)

(72) Inventor: Charles Cox, Cambridge, MA (US)

(73) Assignee: SynchroSystems, Inc., Cambridge, MA (US)

(21) Appl. No.: 17/349,803

(22) Filed: Jun. 16, 2021

Related U.S. Application Data
(60) Provisional application No. 63/040,179, filed on Jun. 17, 2020.

(51) Int. Cl. A01G 31/04; A01G 7/04

(52) U.S. Cl. CPC A01G 31/047; A01G 7/045

(57) ABSTRACT

A container gardening structure has a grow tray with multiple growing stations that extend a radially from a central point of the grow tray. A light fixture has multiple lighting elements disposed above the grow tray to radiate light to the grow tray and extending outwardly from a central axis for the light fixture, with the central axis extending upward from the grow tray through the grow tray central point, and the lighting elements extend along the light fixture such that a distance from lighting elements to the grow tray increases in length from a lowest lighting element to a highest lighting element. The light fixture and grow tray move relative to each other such that the growing stations are moved away from lights that are disposed closer to the grow tray and toward lights that are disposed further from the grow tray.

### CROSS-REFERENCE TO RELATED APPLICATION

This application claims the benefit at least in part of the filing date of U.S. Patent Application 63/040,179, for CONTAINER GARDENING STRUCTURES AND MANAGEMENT THEREOF, filed Jun. 17, 2021 (Attorney Docket No. S05-P01-00US), which is currently pending, the entire disclosure of which is hereby incorporated by reference.

### DESCRIPTION OF THE INVENTION

### Field

The present invention relates to the field of horticulture and particularly to the field of container gardening.

### Background

This invention relates to methods and systems for growing plants. For many people, the growing of fruits, vegetables, flowers, herbs or ornamental plants is a pleasurable hobby and an opportunity to produce plants for food and non-food uses and for personal consumption or profit. Historically, plants have been grown in traditional, outdoors farms and gardens, but today container gardening, also known as pot gardening, is growing in popularity.

Container gardening is the practice of growing plants exclusively in containers instead of planting them in the ground. Suitable containers may be any convenient shape and size, and are often small, enclosed and portable receptacles sized to hold and grow live flowers or plants. Container gardening may include growing edible and/or non-edible plants and is suitable for people with limited space or limited time or for gardeners who live in areas where the soil or other growing conditions (temperature, precipitation, sunshine) are not conducive for a particular plant.

Container gardening may be conducted indoors or outdoors. Frequently container gardeners will grow their plants outdoors in the summer and move the containers indoors when the season changes. In addition, container gardeners may use systems in which plants are disposed in a walled, sealable chamber with one or more doors to provide access to the plants. Plant-growing systems often have a lighting system in which lights are disposed in a horizontal plane that is raised periodically to maintain an optimal distance from the growing plants.

Also, typically, such container gardening systems operate in a batch mode in which multiple plants grow simultaneously, all at the same stage of growth. In batch mode, all of the plants are harvested and processed simultaneously when they mature. Typically, for certain plants, this results in a harvest of multiple plants every few months.

Typically, a plant has a maturation period specific to its type and a height/width/length to which the plant is expected to grow. The variance in maturation periods and expected size across types is large. Container gardening systems may be difficult to design given the wide differences in dimensions (height/width/length) and growth cycles of plants. If the units are designed to accommodate several types of plants, the containers may be over-large, limiting the number of plants that are capable of being grown in a separate container. Further, they may be small or too roomy for growing certain desired plant types, or their light sources may be too far from or too close to the plants or be too intense or insufficiently intense, subjecting the plants to sub-optimal growing conditions.

It is desirable to have simple, convenient, and efficient structures for container gardening systems.

### SUMMARY

Methods and systems for gardening or growing plants are disclosed in which multiple plants in different stages of growth are grown from seeds to mature plants. The plurality of plants may be disposed in a plurality of growing stations extending radially from an interior point of a grow tray. The plants in the growth stations may be disposed in the grow tray in order from a youngest plant to a most mature plant, and the plants in the growth stations may be radiated with light from a light fixture having a plurality of lighting elements disposed in a space above the grow tray.

The lighting elements may have heights associated therewith, with a height being a vertical distance from a lighting element to the grow tray, and with the heights increasing for consecutive lighting elements in the light fixture, from a shortest height between the grow tray and a lowest lighting element, to a highest height between the grow tray and a highest lighting element. A first lighting element may be disposed a first height above a first growing station. When a selected plant in the first growing station has grown a selected amount, the grow tray may be moved relative to the light fixture to position the first growing station under a second lighting element that has a greater height from the first growing station than the first height.

In further embodiments, the second lighting element may be adjacent to the first lighting element on the light fixture. In other embodiments, the plant disposed in the growing station under the highest lighting element periodically may be harvested, a new seed or new seedlings may be planted in an emptied growing station, and the grow tray moving may be moved relative to the light fixture to dispose the newly planted growing station under the lowest lighting element.

In some embodiments, the gardening and plant growing systems and methods may be arranged to operate in any suitable plant-growing outdoors environment; in others, the system may be arranged for indoor operation, or for a combination of indoor/outdoor operation. In certain embodiments, the systems and methods may be arranged to be operated manually; in other embodiments, the system may be arranged to be automated.

The gardening system may have a grow tray and light fixture enclosed in a gardening container, also known as a plant container, or simply a container, that is sized to hold the light fixture and grow tray, with the grow tray having a plurality of growing stations arranged to hold a plurality of plants and to support growth thereof, with the growing stations extending radially from an interior point of the grow tray. In one but not necessarily preferred embodiment, the growing stations have the same length around the perimeter of the grow tray. In other words, the growing stations may be disposed symmetrically around the perimeter of the grow tray.

Further, in one but not necessarily preferred embodiment, the interior point comprises a central point of the grow tray. In other embodiments, the interior point is offset or disposed a selected distance from the center point of the grow tray.

The gardening systems and methods may be operated in a continuous mode in which a plurality of plants grow simultaneously in the grow tray in locations according to increasing maturity; in embodiments in which certain plants in adjacent growing stations are at the same stage of growth, the plants in the grow tray may be arranged in order of non-decreasing maturity.

In either case, the most mature plants may be harvested and processed separate from the other, less mature plants, which are left in the container to reach maturity and themselves be harvested in turn. When plants are harvested from a growing station in the grow tray, they may be replaced in the chamber with seeds or seedlings (in this disclosure going further, the term “seedling” may refer to immature plants, seedlings, or sprouts), that also mature and are harvested in turn. The cycle of selective planting, growth, and harvest results in a more continuous harvesting of crops from the container, producing a crop from the container in a fraction of the overall plants' maturity time. While an individual plant may require several weeks or months to reach maturity, cultivating that plant in a container that supports cultivation of multiple plants at multiple, non-decreasing stages of growth allows a harvest to be produced every few weeks.

The container gardening system may be sized to hold have a light fixture with a plurality of lighting elements disposed in space above the grow tray at monotonically increasing (or, in other embodiments, monotonically non-decreasing) selected distances from the grow tray. The lighting elements may extend outwardly from a central axis of the light fixture, with the central axis extending orthogonal to the grow tray upward from the grow tray through the central point of the grow tray. In certain embodiments, the light fixture may be helical, with lighting elements disposed along the helix such that a distance from consecutive lighting elements to the grow tray increases in length from a lowest light fixture to a highest light fixture. In certain other embodiment, the lighting elements may be arranged at discrete locations along the light fixture to radiate light from discrete locations. In other embodiment, the lighting elements in a light fixture are arranged continuously to radiate light continuously to the plants in the growth stations in a grow tray which may have discrete growing stations for plants or which may have a continuous growing length in which plants may grow along the grow tray in non-decreasing order of maturity.

The lighting elements may have heights associated therewith, with a selected height being a selected vertical distance from a selected lighting element to the grow tray. The heights may monotonically increase, or in certain embodiments not monotonically decrease, across the light fixture, from a shortest height between the grow tray and a lowest lighting element, to a highest height between the grow tray and a highest lighting element, with a first lighting element disposed a first height above a first growing station. For the plurality of plants in the grow tray, the distance from a selected lighting element to a selected plant is optimal for the selected plant's stage of growth.

As a selected plant in a selected growing station grows taller, the grow tray may be moved relative to the light fixture to increase the distance between the lighting element and a growing station. In certain embodiments, the light fixture is rotatable around the grow tray moved and the grow tray remains stationary. In other embodiments, the grow tray moves and light fixture remains stationary. In still other embodiments, the grow tray light fixture remains stationary, and a plurality of growing stations, which may constitute individual growth containers, move along and around the grow tray. A movement controller may be provided for moving the light fixture and the grow stations relative to each other to position the first growing station under a second lighting element that has a greater height from the grow tray than the first height.

No matter how the relative movement of the plants and the lighting elements is produced, the relative movement of the plants and lighting elements may cause a selected distance to be maintained between the plants and lights, with the distance between plants and lighting to increase in proportion to the increasing maturity of the plant, to optimize the lighting for all of the plants at all stages of growth. Periodically mature plants may be harvested and processed and new seeds or seedlings may be introduced into the system.

The disclosed apparatuses, methods and systems are very adaptable and may be used to simply, conveniently, and efficient grow plants at different stages of growth in a container and to provide for near continual harvesting of crop from the container.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1A is a perspective view of an illustrative but not necessarily preferred embodiment of the interior of a container gardening structure 100, with its exterior casing and equipment bay removed;

FIG. 1B is a side perspective view of the interior of the container gardening structure 100 of FIG. 1A, including representations of plants undergoing growth therein;

FIG. 1C is a front perspective view of the interior of the container gardening structure 100, with container walls of the front-facing exterior casing removed and showing the vertical supports of the exterior casing and an equipment bay;

FIG. 1D is a perspective breakaway view of the equipment bay 150 shown in FIG. 1C, showing representations of equipment bay components;

FIG. 1E is a perspective view of the exterior of the container gardening structure 100;

FIG. 2A is a perspective view showing an illustrative but not necessarily preferred embodiment of a lighting panel 200 for use in a container gardening structure 100;

FIG. 2B is a top view of the rotation system 210 of the container gardening structure 100 shown in FIG. 1A, with the top container cover 104, and most of the elements disposed in the interior of structure 100 removed;

FIG. 2C is a sectional view of the rotation system 210, cut along broken line C-C′ in FIG. 1C and with the light fixture removed;

FIG. 2D is a sectional view of the fluid handling system 220, cut along broken line D-D′ in FIG. 1D and with the light fixture removed;

FIG. 2E is a partially schematic view of the fluid handling system 220 shown in FIG. 2D;

FIG. 2F is a flow chart showing an ebb and flow cycle 270 for operating the fluid handling system shown in FIGS. 2D and 2E;

FIG. 3A is a flow chart showing an illustrative but not necessarily preferred embodiment of a cultivation cycle 300 for growing plants in a container gardening structure 100;

FIG. 3B is a diagrammatic view of the phases and states of condition of the grow tray in an initial cultivation sequence 310 of the cultivation cycle 300;

FIG. 3C is a diagrammatic view of an illustrative but not necessarily preferred initial cultivation sequence 310 of the cultivation cycle 300;

FIG. 4A is a diagrammatic view of the phases and states of condition of the grow tray in a continuous cultivation sequence 410 of the cultivation cycle 300 and the transition from the initial cultivation sequence 310 to the continuous cultivation sequence 410;

FIG. 4B is a diagrammatic view of an illustrative but not necessarily preferred continuous cultivation sequence 410 for the cultivation cycle 300;

FIG. 5A is a flow chart showing an illustrative but not necessarily preferred embodiment of a cultivation cycle 500 for growing plants in a container gardening structure 100; and

FIG. 5B is a diagrammatic view of an illustrative but not necessarily preferred embodiment of the last state 315 in the initial cultivation sequence 310.

### DETAILED DESCRIPTION

Reference will now be made in detail to the present exemplary embodiments of a container gardening structure 100, examples of which are illustrated in the accompanying drawings. Wherever possible, the same reference numbers will be used throughout the drawings to refer to the same or like parts.

### Gardening Container 100

A container gardening structure 100, also known as a plant-growing container, gardening container, or container, may be used for the controlled growth of plants, especially indoors, and especially for controlled growth of plants such as herbs, spices, and flowers, according to the present invention.

The container 100 may be operated manually, or via timer, or it may be part of a container gardening system that provides automated operation with a computer-enabled control system, which may be located in whole or in part in the equipment chamber. The container 100 may be a single standalone container gardening structure in a single location. Alternatively, multiple containers 100 may be disposed in a single facility in a single location, or in a single facility in multiple locations. One or more structures may be disposed individually or in groups in a myriad of locations such as throughout a city, in the suburbs, or in rural areas, in residential, office, industrial, and recreational area sites, and in buildings or facilities near to such sites. Apartment complexes, office parks, and tourist areas may have dedicated container gardening facilities. The container may be one single level high, or it may have multiple levels.

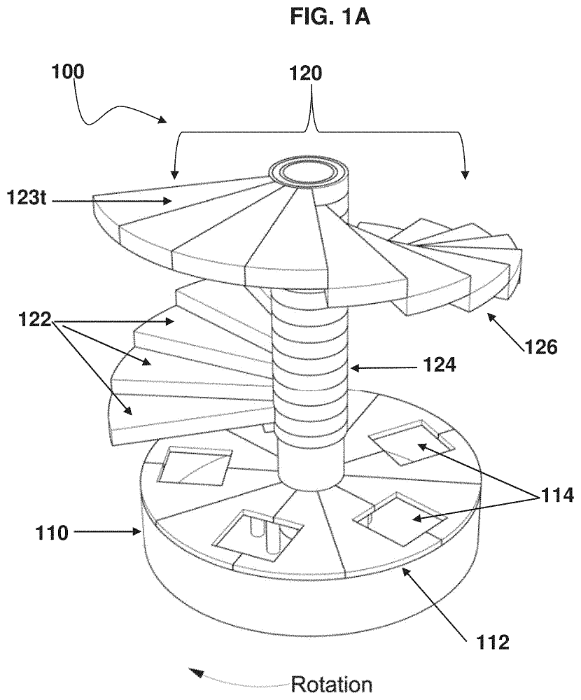

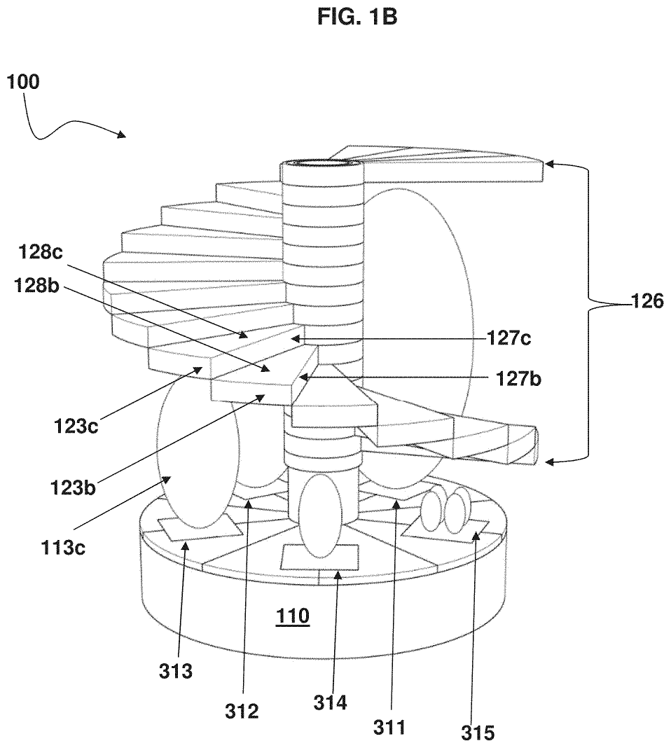

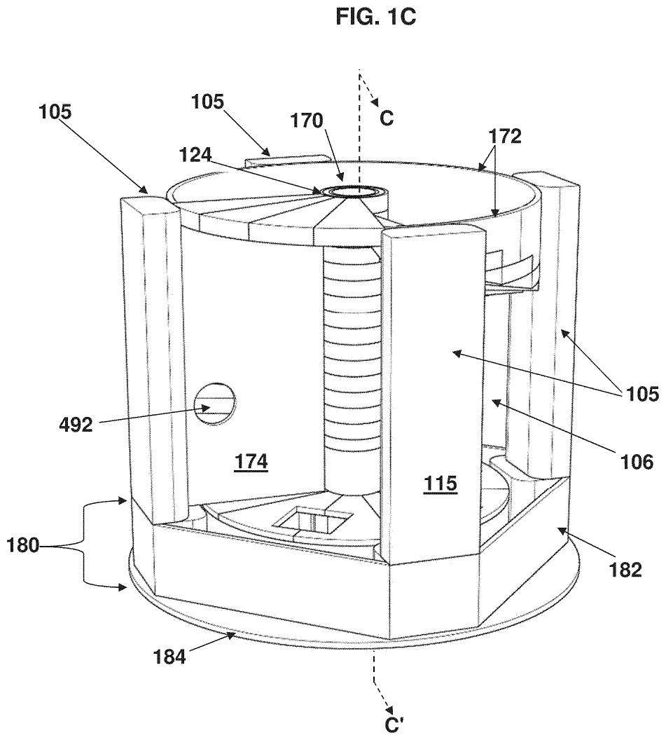

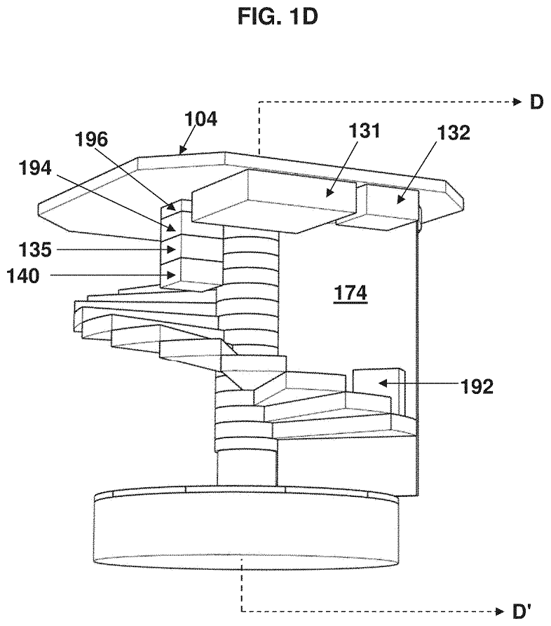

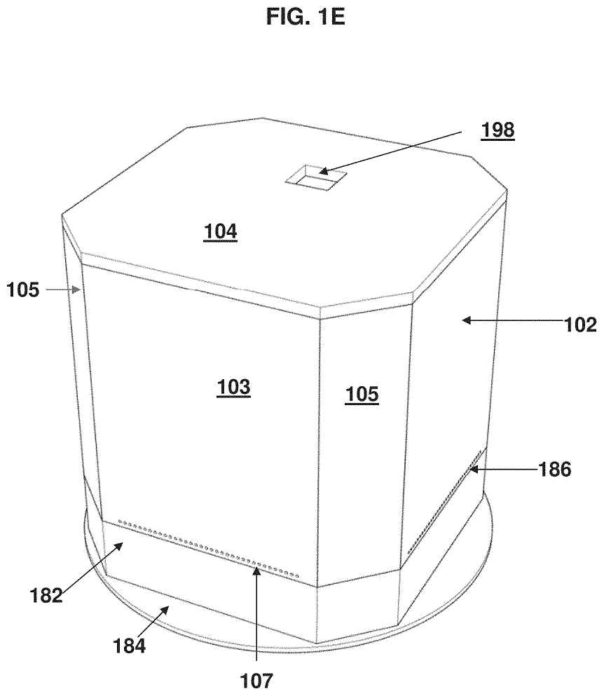

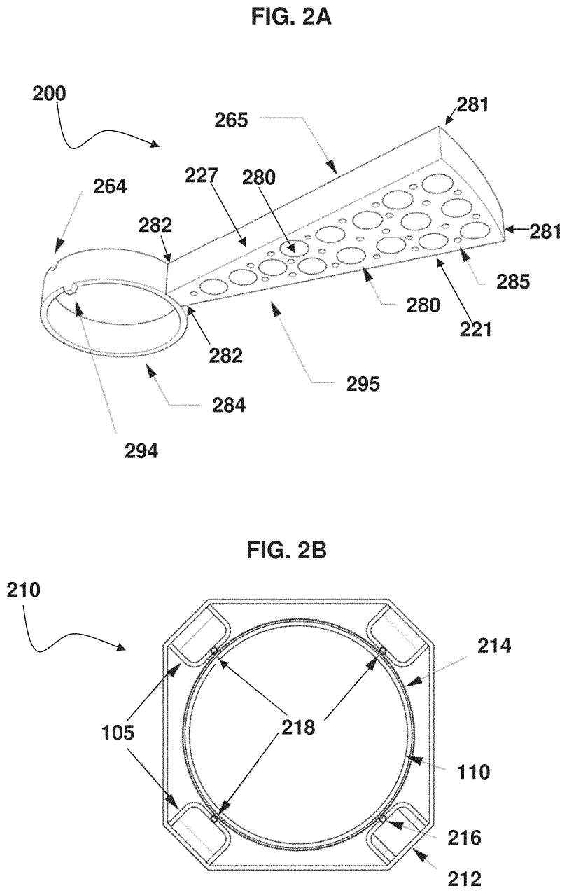

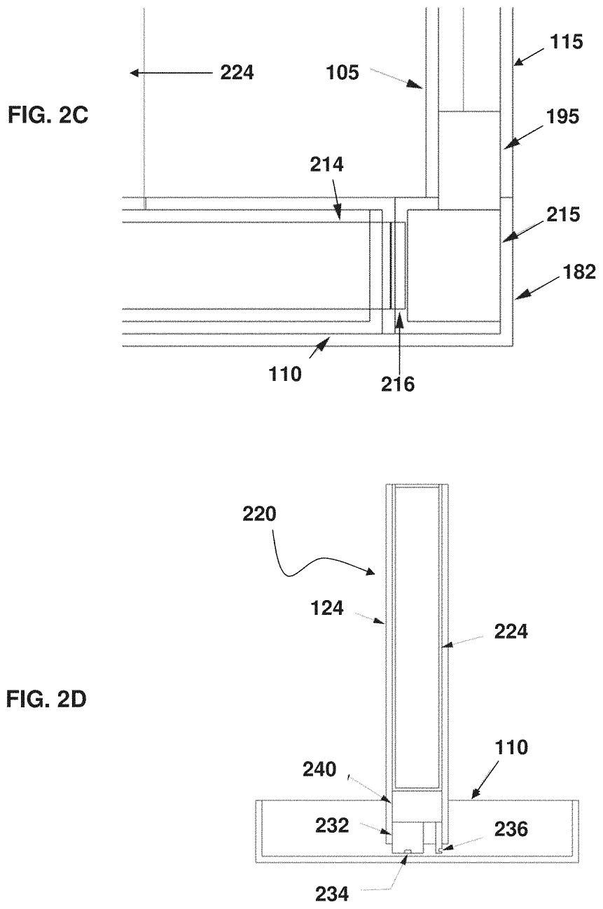

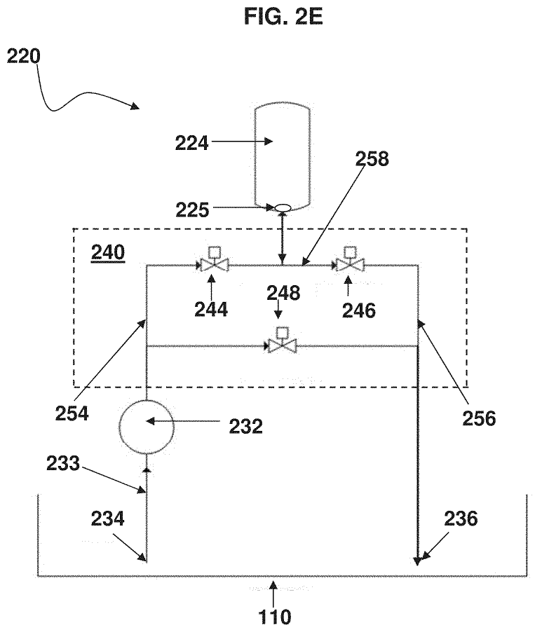

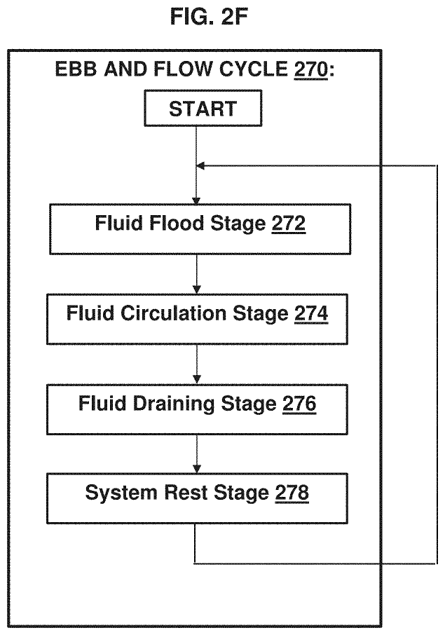

The container(s) will be described in detail with reference to FIGS. 1A to 1E of the accompanying drawings. In the embodiment shown in FIGS. 1A-1E, the container 100 is intended for indoor use; however, the enclosure may be modified for outdoor operation. The container gardening structure 100 may have a grow tray 110 arranged to hold growing plants, for example in growing stations disposed in the grow tray 110 at increasing stages of growth, in order from a youngest plant to a most mature plant. It may also have a light fixture 120 with a plurality of lighting elements 122 that may be disposed in space above the grow tray 110 at increasing selected distances from the grow tray 110. In certain embodiments, the light fixture 120 may be helical, with lighting elements disposed in, on, or extending from a central column 124 of the container 100 along a helix 126, which is a curve or cone shape on the light fixture in the form of a spiral that extends around the central column. In certain embodiments, the lighting elements are arranged in a single turn of the spiral or cone shape on the helical path. The lighting elements, which made be formed of modular light panels 200 (shown in FIG. 2A and described in greater detail below) may be arranged to radiate light to the plurality of growing plants, which are disposed in the grow tray 110 at increasing stages of growth, such that, as shown in FIG. 1B, for the plurality of plants in the grow tray, the distance for a selected plant 113c from lighting to the grow tray 110 is optimal for the selected plant's stage of growth. In embodiments in which there is a one-to-one correspondence between plants and lighting elements and the rotation occurs in one movement per growth stage, the distance for a selected plant 113c from a lighting element to the grow tray 110 is optimal for the selected plant's stage of growth. In embodiments in which there is not a one-to-one correspondence between plants and lighting elements or the tray rotates continuously or near-continuously, the distance for a selected plant 113c from a set of lighting elements to the grow tray 110 is optimal for the selected plant's stage of growth.

In certain embodiments, there need not be a one-to-one correspondence between plants and lighting elements. For example, in certain embodiments, the tray is arranged to rotate continuously or nearly continuously under the lights and a one-to-one correspondence between plants and lighting elements is not necessary. In other embodiments, the interior or inner surfaces of the container are reflective so that plants may be exposed directly and indirectly to direct and indirect light from the lighting elements.

### Container Structure

Referring to FIGS. 1C and 1E, the container 100 may have a container base 180, one or more container walls 102 (also known as walls or wall panels 102) extending upwardly from the container base 180, vertical supports 105 disposed at a bottom end upward from the container base 180 and at a top end to a top container cover 104, and a chamber 106 defined by the container base 180, the container walls 102, the equipment bay, described below, and the top container cover 104. A container enclosure is defined by the container walls 102 and the vertical supports 105, which may rest on the upper base and support the container cover. The walls 102 form part of the exterior of the structure and serve to separate airflow inside the chamber from the air outside. Additionally, the walls 102 may have a reflective surface to allow plants to be exposed to direct and indirect light.

In the illustrative but not necessarily preferred embodiment of FIGS. 1A-1E, the container walls are shown as flat and, in combination with each other and the vertical supports 105 form a truncated square in plan view. The container walls 102 may be formed of one or more rigid materials; the materials may have the same amount of rigidity, or the materials may not have the same amount of rigidity. Alternatively, one, more, or all of the wall panels may be formed of a non-rigid material that is hanging from or stretched over a frame. The container may be completely formed of rigid panels, or rigid panels may be selectively incorporated into the container 100 to provide better air control and more even reflectivity than flexible ones. In addition, no matter the amount of rigidity of the materials from which the container walls are constructed, in the illustrative but not necessarily preferred embodiment of FIGS. 1A-1E, the wall material may be reflective to allow the light to be reflected into the interior of the chamber 106 to optimize the amount of light delivered to the plant. In addition, the existence and relative rigidity of the wall material may function to control air flow.

The container wall may be a single piece of a plastic material, or it may be several pieces that together operate, with a container cover 104 that extends across the container 100 at or near the top of the container wall 102, as an enclosure for the container 100 and a route for connections between the vertical supports and central column.

In the illustrative but not necessarily preferred embodiment of FIGS. 1A-1E, the container cover may be a single rigid panel, but in other embodiments, the container cover may be constructed of more than one component or section.

The container wall 102 may have one or more doors 103 for providing access to the plants. In certain embodiments, one or more segments of the wall 102 may operate as a door 103 to the chamber 106. In the illustrative but not necessarily preferred embodiment shown in in FIGS. 1A-1E, the segments of wall 102 may all operate as doors to allow easy access to all of the plants. In the embodiment shown in in FIGS. 1A-1E, the segments of the wall may be attached between vertical supports 105 disposed upward from the container base 180, with the wall segments attached to vertical supports 105, for example by a hinge and latch system (not shown) to form doors along the container 100. In other embodiments (not shown), a door may be formed separate from the wall segment, formed of one or materials that are different from or the same as the wall segment the door may be attached into a door opening in the wall segment, for example by a hinge and latch or a slider system.

The interiors of the vertical supports may be used to house equipment or store fluids. They also may be arranged to provide attachment points for cameras and doors. Cameras (not shown), which may be located on the vertical supports below the lights, may be positioned to image the tops of the plants in order to determine the distance between the plants and lights, so as to measure the growth of the plants.

In certain embodiments, a portion or all of the interior surface of the wall 102, including without limitation the doors, is reflective to distribute light around the chamber 106, and they may bear registration marks (not shown) for use by a camera system (also not shown). In the illustrative but not necessarily preferred embodiment of FIGS. 1A-1E, container walls extend from the container cover 104 to the base, and may have one or more ventilation holes near the base to provide ventilation.

In certain embodiments, such as is shown in FIG. 1E, the ventilation holes may be air intake holes such as holes 107 shown on the doors 103 on the container wall 102 in FIG. 1E. In embodiments such as shown in FIG. 1E, in which ventilation air flows upward, the holes 107 constitute ventilation holes disposed in the bottom of the chamber walls and through which air enters the chamber; and air exits at the top of the chamber through exhaust fan port 198.

In FIG. 1E, the air intake holes 107 constitute a series of ventilation holes disposed on the bottom of the wall 102, but in other embodiments, the air holes may be disposed on more than one wall and at any location on a wall, whether at the top, in the middle, or at the bottom. Further there may be any number of holes, from one to several, arranged in a line such as in FIG. 1E or in any design and at any location selected by the designer.

In other embodiments, in which ventilation air flows downward, entering at the top through one or more openings such as exhaust fan port 198 and exiting at the bottom, the holes may constitute ventilation outlets through which the air may exit.

In other embodiments, the container walls may not extend to the container cover and/or base; instead, netting, screening, glass/plastic or other materials, may cover the areas not covered by the container walls.

Further, a variety of embodiments of container geometries are contemplated. In one embodiment, the container is generally circular or has curved walls. In other embodiments, such as shown in FIG. 1E, the container is polygonal in cross-section. In addition, the container walls themselves may be solid or they may be formed from fencing, slats, (as noted above) a non-rigid or flexible material that is hanging from or stretched over a frame, or any enclosing material, selected at the option of the designer. In certain embodiments, the container is enclosed to protect the chamber 106 from the elements; in other embodiments, the container may be partially enclosed to allow ventilation while still providing partial protection from the elements. In further embodiments, vents, windows that open, or other ventilation features may be provided in the container walls, to be opened or closed automatically or manually at the option of the designers and/or the facilities management.

A power supply, for converting wall power to the various voltages required by the container system, may be located in the equipment chamber.

### Container Base 180

In the illustrative but not necessarily preferred embodiment of FIGS. 1A-1E, the container base 180 may include an upper base 182 and a lower base 184 disposed on a floor. The upper base 182 may support components above it, such as the container wall 102 and the vertical supports 105. The vertical supports 105 may be arranged to rest on the upper base 182 and support the container cover 104. The interiors of the supports 105 may be used to house equipment or store fluids.

The upper base 182 may be sized to hold the grow tray 110, with the upper base 182 having base sidewalls 186 that extend to a selected height to allow the upper base 182 to function as a leak containment vessel for the grow tray so that the fluids disposed in the chamber 106 are securely contained. In certain embodiments, as in the illustrative but not necessarily preferred embodiment of FIGS. 1A-1E, the base sidewalls 186 may extend to the height of the grow tray 110. The upper base 182 may be rotatable freely on the lower base 184, disclosed in greater detail above and below, to provide access to the plants in the grow tray 110.

Also as shown in FIGS. 1C and 1E, the lower base 184 may be disposed below and supports the upper base 182 of the container 100. In embodiments such as FIGS. 1A-1E, the lower base 184 is stationary, with, as described below, a rotating structure disposed on the lower base 184 rotating the upper base 182. In the illustrative but not necessarily preferred embodiment of FIGS. 1A-1E, the rotating structure may be a thrust bearing that is mechanically connected to the grow tray for automatically rotating the grow tray under the stationary light fixture. The rotating structure may be formed of a material such as plastic and is integrated into the upper and lower bases. In other embodiments, the rotating structure may be a turntable.

The upper base 182 shown in FIGS. 1C and 1E, forms a truncated square in plan view, however other shapes are possible and may be selected at the option of the designer. The lower base 184 in shown in FIGS. 1C and 1E, forms a circle in plan view, however other shapes are possible and may be selected at the option of the designer, so long as the perimeter of the lower base encompasses the swept area of the upper base 182. The swept area is the circle under the upper base that the upper base covers during a full rotation of the upper base. In order to allow the upper base 182 to rotate freely when the container is placed against a wall or in a corner, the lower base 184 may be sized to extend beyond the swept area of the container 100, allowing the components of the container 100 the footprint to rotate while the container 100 is disposed be against a wall or corner. For example, in one embodiment, the swept area of the upper base 182 may constitute a circle inscribed within the perimeter of the lower base 184.

### Grow Tray

The grow tray 110 is a tray that is sized to hold plants undergoing growth. The tray 110 may rest on or in the upper portion of the container base 180. In certain embodiments, the grow tray 110 may have a plurality of compartments (not shown), which may be known as growing stations, that are sized for housing one or more plants during their growth cycles. Although the description of illustrative embodiments below refers to growing stations, in other embodiments, the grow tray may be an open pan sized to hold the plants and a growth medium, in which case the boundaries of growing stations may be considered to be virtual.

In either case, the grow tray 110 may be generally circular in cross-section and may define a plant bed into which plants and plant nutrient may be contained. In one illustrious but not necessarily preferred embodiment, the grow tray may be a tub that is generally round in cross-section with a generally flat-bottomed bottom surface and an outer tray sidewall extending around and up to a selected height above the perimeter of the bottom surface to allow the grow tray 110 to function as a fluid containment vessel so that the fluids disposed therein are securely contained. As shown in FIG. 2D, the tub may be disposed under the central column 124, with the bottom edge of the central column 124 close to but not touching the bottom surface of the grow tray.

The grow tray 110 may be arranged to hold plants of increasing maturity (and therefore of increasing height) around the grow tray such that plants of increasing height may be disposed around the grow tray, with the tallest plants adjacent to seeds or seedlings (or, in certain embodiments adjacent to a grow tray region that is empty due to the plants therein just having been harvested).

Growing stations in a grow tray may be sized by the designer to contain one or more plants of one or more selected types. For example, a plant of a first type may tend to grow to a larger size than a plant of a second type; and the size of a growing station for growing the plant of the first type may be larger than the size of a growing station for growing a plant of the second type. In addition, growing stations may be sized by the designer to contain one or more plants of an intended type at different stages of growth, including a size that accommodates a plant of a stage of growth that the designer determines to be ready for harvesting. For example, in the illustrative but not necessarily preferred embodiment of FIGS. 1A-1E, a plant of a selected type may be deemed by a designer to be ready for harvesting when it is a fully mature plant, and a growing station may be sized to contain a full mature crop. Alternatively, a designer may decide that harvesting is appropriate when the plant is not quite fully mature, and the size of the growing stations for such a plant growing system may be smaller than in a plant growing system designed to support fully grown plants of the intended type.

The container 100 may have a grow tray cover 112 sized to fit over the top of the grow tray 110. The grow tray cover 112 may have multiple openings 114 (in certain embodiments, spaced evenly around the edge of the pan) to cover the grow tray but allow the plants to grow through, with the plant's root system and growth media below the grow tray cover and the rest of the plant above the grow tray cover. Accordingly, the multiple openings 114 may define growing stations in the grow tray.

The growing stations may be sized and configured to contain a growth medium to support the growing plants. In certain embodiments, the growth medium may be a potting soil or nutrient-rich gel or other colloidal plant growth-supporting material. In the illustrative but not necessarily preferred embodiment of FIGS. 1A-1E, the planting system is designed to employ a hydroponic technique; the hydroponic growth medium may be mineral wool cubes described below.

The grow tray cover 112 may operate to reduce evaporation of liquids in the growth medium by reducing airflow over the growth medium, and it may reduce algae growth by blocking light from reaching the growing station. The grow tray cover 112 may also bear registration markings (not shown) for the camera system.

In certain embodiments, the grow tray cover 112 may have multiple removable wall panels. The wall panels may be removed to allow mature plants to be removed from the grow tray 110 and to allow access for cleaning the grow tray 110.

In the illustrative but not necessarily preferred embodiment of FIGS. 1A-1E, the grow tray 110 is circular in the plan view, however in other embodiments, other shapes are possible. In the embodiment of FIGS. 1A-1E, in which the plants are rotated around the central column, for example by action of a turntable, the grow tray may be a single rotating ring that extends around the circumference of the central column. However, in other embodiments, for example, those in which rotation may be accomplished with a closed-loop conveyor of any shape, the grow tray may have multiple concentric grow tray rings, allowing for multiple types of plants, with different growth rates, to be grown simultaneously.

The number of plant positions in the grow tray is at the discretion of the designer. For example, and as noted above, a grow tray may have discrete growing stations defined by compartments in the grow tray, or it may have openings in the grow tray cover through which growing plants may be exposed to the light, thus defining growing stations. In certain other embodiments, the plants may be disposed around the grow tray continuously with no defined growing stations, in which case a system designer or gardener may define arbitrary locations around the grow tray as centers of growing stations, thus defining a designer or gardener-chosen set of virtual growing stations. Irrespective of how growing stations are defined, the number of plant positions may be application dependent and a function of the plant's maturation period and the desired harvest interval.

For example, the number N of plant positions may be selected in accordance with the equation (1) when the grow tray has one empty position:

N=(plant maturation period/harvest interval)+1. (1)

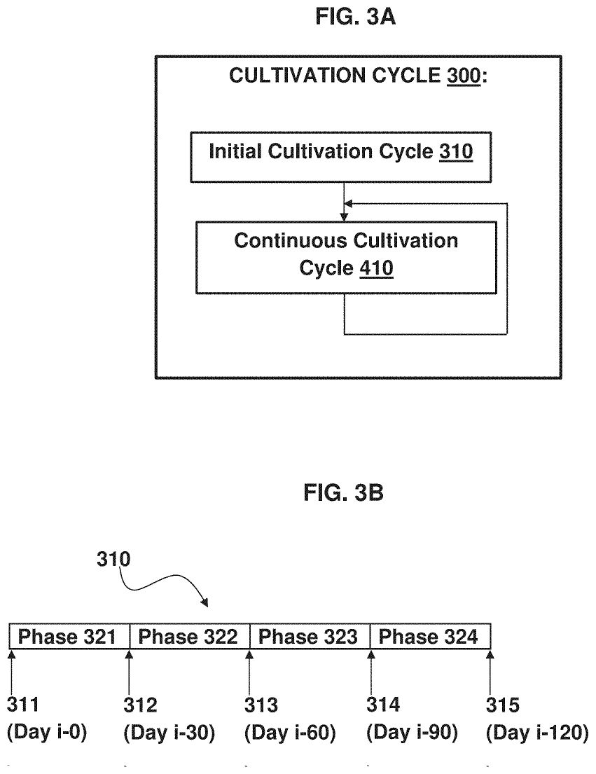

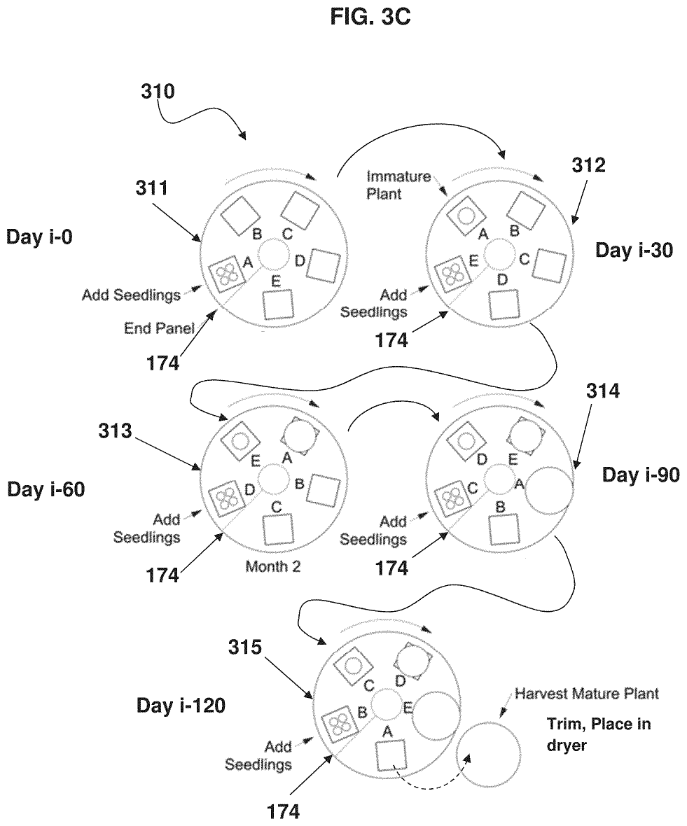

FIGS. 3A and 3B show an example of an initial cultivation sequence of a plant in which the plant maturation period is 120 days and the harvest interval is 30 days. Accordingly, N=(120/30)+1=5; and the grow tray cover 112 may have five openings to support five plant positions in the grow tray 110.

In certain embodiments, the growth medium may be a potting soil or nutrient-rich gel or other colloidal plant growth-supporting material. In the illustrative but not necessarily preferred embodiment of FIGS. 1A-1E, in which the planting system is designed to employ a hydroponic technique, the growth medium may be mineral wool cubes described below. The illustrative but not necessarily preferred embodiment shown in FIGS. 1A-1E is based on an “ebb and flow” hydroponic system; however, the container 100 may be modified to support other hydroponic systems, such as wick systems, deep water culture, nutrient film technique, aeroponics, or drip systems. In other embodiments, non-hydroponic growth media may be used, including soil and non-soil media.

The illustrative but not necessarily preferred embodiment of FIGS. 1A-1E supports growing plants in off-the-shelf cubes of mineral wool as a hydroponic growth medium, Mineral wool, also known as stonewool, is ideal for seed starting, ebb and flow systems, and drip irrigation hydroponic systems due to its inert properties and its ability to not absorb water—leaving the water available to the plants for growth and development. Stonewool cubes are available from Grodan (ROCKWOOL B.V.) of Roermond, The Netherlands.

In addition, the bottom of a hydroponic grow tray may be sloped downwardly toward the center of the tray to facilitate pumping the nutrient solution from the tray to the nutrient solution tank. Fluid handling is discussed in more detail below. Also, the cross-section of the grow tray may be any shape desired by the designer, but in the illustrative but not necessarily preferred embodiment of FIGS. 1A-1E, the cross-section of the grow tray 110 is circular.

### Rotation System

In certain embodiments of container gardening systems, the grow tray may be stationary and the light fixture rotatable, but in the illustrative but not necessarily preferred embodiment of FIGS. 1A-1E, the grow tray 110 is rotatable and the light fixture 120 remains stationary. Rotation may be implemented using any conventional method, such as using a closed-loop conveyor of any shape, but in the illustrative but not necessarily preferred embodiment of FIGS. 1A-1E, the grow tray 110 may rotate on the upper base 182 manually or under motor control. In the illustrative but not necessarily preferred embodiment of FIGS. 1A-1E, a rotation system 210 has a rotation motor 195, which in certain illustrative but not necessarily preferred embodiments, may be located in one of the vertical supports. In the embodiment shown in FIG. 2C, the rotation motor 195 may be located in the vertical support 115 (which is the vertical support adjacent to an end of the top lighting element 123t, which is the highest lighting panel in the helix). The rotation motor may be provided to rotate the grow tray and increase the vertical distance between the plant and the lights, and a computer-enabled control system, having a processor and multiple interfaces, may be provided for controlling the motor.

In general, the average degrees of rotation per day may be derived by:

$$\frac{360 °}{plant maturation period + harvest interval}$$

In an embodiment in which the plant maturation period is 120 days and the harvest interval is 30 days, the average rotation speed is 2.4°/day. The speed and frequency of the movements may be selected by the system designer or the user. For example, the rotation may occur in a few, relatively larger movements of the plants relative to the lighting elements; making numerous, relatively small movements, or an even larger number of small movements so as to approach continuous movement.

Continuing with the above plant embodiment, when the plant growing system has a grow tray with five growing stations, rotation may be performed in five increments of 360/5=72°, or rotation may be performed in 150 daily movements of 2.4°, or in 150(n) increments of [(2.4)/n]°, where n is selected by the designer or the user. In the illustrative but not necessarily preferred embodiment, numerous movements occur slowly, resulting in a near-continuous rotation selected to avoid stressing the plants and to reduce pinch hazards.

In certain embodiments, the rotation motor 195 may be arranged to activate when the following conditions are met:
The grow tray is rotatable without damaging the mature plant;
At least one plant is too close to the lights; or
In a hydroponic system, the nutrient solution is in the nutrient tank such as tank 224, which is described in more detail below.
   In still further embodiments, the rotation motor 195 may be arranged to activate when all of the above-enumerated conditions are met. In addition, the growing system may have sensors (not shown) to collect data to be used to determine whether the above-enumerated conditions may be met.

In still further embodiments, the rotation motor 195 may be operated open-loop or it may be operated closed-loop using a position feedback sensor (not shown) or by processing camera images from a camera (not shown) to determine the tray position. The rotation motor 195 may be operated in response to a plant height sensor (not shown). Alternatively, when a plant height sensor is not used, the rotation motor 195 may also be operated by a conventional timer.

The rotation motor 195 may be may be used to rotate the grow tray under computer, timer, or manual control. The rotation motor may drive the grow tray using any of a variety of mechanisms such as belt, gear, or direct drive. A thrust bearing may be located between the upper base and grow tray in order to reduce rotational friction between those surfaces. In certain embodiments, a drive unit, which may be any conventional drive unit, may be attached to the top of one of the vertical supports 105 to provide rotation, for example, of the lights from the top of the container or of the grow tray 110 or of the grow tray when the grow tray is attached to the central column (or a post running therethrough) and the drive unit controls rotation of the central column (or a post running therethrough). In other embodiments, such as shown in FIGS. 2B and 2C, a rotation system 210 may have a drive unit 212 that may be disposed in the bottom of one of the vertical supports 105. The drive unit 212 may have the motor 195 and a gear box 215 with a drive gear 216 attached to the bottom of one of the vertical supports 105 and arranged to allow the drive gear 216 to translate the output of the motor 195 into driving power and transfer the driving power to the grow tray gear 214, which may be attached to or engaged with the grow tray. In other embodiments, the drive unit 212 may rotate the grow tray or lights using a wheel or belt. As shown in FIG. 2C, idler gears 218 may be positioned at the lower portion of one or more the vertical supports 105 in order to keep the grow tray in position and smooth the rotation.

The rotation motor may incorporate position feedback to a movement controller in the control system. To reduce the motor size and power consumption, in certain embodiments, rotation of the grow tray may be limited to when the grow tray is empty of nutrient solution. To further reduce motor size, power consumption, stress on the plants, and to reduce pinch hazards, the motor may be arranged to rotate slowly, making frequent small movements.

### Central Column

The chamber 106 may also have a central column 124 located in the interior of the chamber 106. In certain embodiments, the central column may be attached to and extend downwardly from the container cover 104. A central column 124 extending downwardly from the container cover 104 may be freestanding or it may be connected to the lower base 184. In certain embodiments, the central column may have a vertical support such as a rod attached to and running through the interior of the central column, with the rod attached to the central column, which itself rotatable may be around the rod. Further, the central column may be used to support the light fixture 120, disclosed in more detail below. The bottom of the central column 124 may be suspended above the bottom of the grow tray 110, or the thrust bearing (not shown) may be used to transfer weight to the grow tray. In other embodiments, the central column 124 may extend upwardly from the lower base 184.

Further, in certain embodiments, the central column 124 may be located in the center of the chamber 106 with the center column 124 along an axis extending orthogonal to the grow tray from the bottom surface of the grow tray. In certain embodiments, the central column is touching or attached to the grow tray. In other embodiments, the central column is suspended just above the bottom of the grow tray.

In further embodiments, the center column 124 may extend around a vertical axis that passes though the center point of the bottom surface of the horizontal grow tray; and in other further embodiments, the central column 124 may extend orthogonal to the grow tray from the bottom surface of the grow tray but offset from the center point of the grow tray. An offset column may provide growing stations with more growing space for a plant reaching maturity by providing growing stations with greater width as a plant matures, allowing the larger plants to stretch out radially in the container.

The central column 124 may be used to house equipment. The central column 124 may also be used to store fluids, for example a nutrient solution, which may be stored in a stationary nutrient tank 224, for transfer between the nutrient tank 224 and the grow tray 110. The nutrient tank 224 is arranged to contain the hydroponic nutrient solution when it is not in use. In certain embodiments, it may be located in the central column and/or in one or more of the vertical supports.

In certain embodiments, the exterior of the central column 124 may be reflective to help distribute the light from the light fixture, disclosed in more detail below. In other embodiments, the central column may be optional, and the light fixture 120 may be supported by a container component that is different from the central column 124 (for example, by the vertical supports 105, with the fluid transferred to the grow tray 110 by a system that does not involve the central column 124.

### Light Fixture

In the embodiment shown in FIGS. 1A-1E, the central column in, on, or from which a light fixture may be disposed may extend upward in the container. The light fixture 120 may helicoidal in geometry and hold a plurality of lighting elements 122 spaced along the helix so that the lighting elements are attached to the central column 124 in an ascending arrangement similar to a spiral staircase. In the embodiment shown in FIGS. 1A-1E, multiple horizontal lighting elements 122 are formed from lighting panels that are joinable with adjacent lighting panels, installed into the central column to form the helix, however the helix may be constructed at the option of the designer from one or more lighting elements in any orientation. For example, a designer may choose to construct the helicoid from multiple horizontal lighting elements, such as shown in FIG. 2A, in order to simplify manufacturing and shipping, or he or she may construct this design however it may be constructed from a continuous helicoid lighting panel.

The helicoidal shape of the illustrative but not necessarily preferred light fixture 120 allows for an increase of station height (also known as a light fixture/grow tray height and comprising the distance in the chamber between light fixture and grow tray) around the perimeter of the grow tray to accommodate the heights that the plants in the growing stations in the grow tray are expected to reach, starting with a minimum station height (comprising a shortest light fixture/grow tray height at a growing station which require the least amount of less growing station height). In certain embodiments, the minimum station height is disposed above a growing station containing no seedlings or seeds, and in other embodiments, the minimum station height is disposed above a growing station containing the seedlings or seeds. In the illustrative but not necessarily preferred embodiment of FIGS. 1A-1E, the end panel 174 may be disposed between a growing station having the minimum station height and a growing station having the maximum station height.

In certain embodiments, at least one lighting element may be formed of a single lighting panel; in other embodiments, at least one lighting element may be formed of a plurality of lighting panels joined together. In certain embodiments, the end panel may be a vertical structure arranged to fill the gap between the lowest and highest parts of the light fixture and extend down to the grow tray cover.

The station heights may be selected to accommodate the expected heights of plants intended to be grown in the container 100, at selected stages of growth according to a plant growth pattern for the plants' type. As the plants and lighting elements move relative to each other, the growing stations of the grow tray move to positions in which their respective station heights increase. The angle between the light fixture 120 and the chamber exterior may be changed to accommodate different sizes and numbers of plants. The angle may be set to optimize access to both the fully mature plant under the highest part of the fixture and the seedlings or seeds under the lowest part of the fixture.

When the growing station containing the tallest plants that is contiguous to the edge of the growing station with the shortest light fixture/grow tray height reaches the maximum station height, it is ready for harvesting.

In one illustrative but not necessarily preferred embodiment, the set of growing stations in the grow tray may be associated with a set of station heights, which may be associated with a set of expected plant heights, which in turn may be associated with a set of selected stages of plant growth. In one further illustrative but not necessarily preferred embodiment, the station height of a selected growing station in the grow tray may be based on an expected plant height, which may in turn be based on a selected stage of plant growth.

In the illustrative but not necessarily preferred embodiment of FIG. 2A, the helix has a fixed-pitch; however, a variable-pitch helix may be used to accommodate non-linear plant growth patterns.

The type and number of lighting elements, their spacing along the helix, and the intensity of light they emit are selectable by the designer based on preferences and desired system specifications. For example, in certain embodiments, the lighting elements need not be spaced uniformly along the helix, while in the illustrative but not necessarily preferred embodiment of FIGS. 1A-1E, the elements are spaced evenly along the helix. In certain embodiments, the number of lighting elements may correspond to the number of growing stations in the grow tray 110 so that each growing plant has one or the same number of lighting elements associated therewith. In other embodiments, the number of lighting elements need not correspond to the number of plant stations in the grow tray.

In the illustrative but not necessarily preferred embodiment of FIGS. 1A-1E, the lighting elements are disposed continuously or near-continuously along the light fixture; such placement of lighting elements is convenient when the plants in the grow tray are disposed continuously along the grow tray. In certain embodiments, the elements emit the same amount of light intensity. In the illustrative but not necessarily preferred embodiment of FIGS. 1A-1E, different-sized lighting elements produce different light intensity, distribution and spectra, with the lower-disposed lighting elements (the elements disposed closer to the grow tray) producing less light than the higher-disposed lighting elements. The lower-disposed lighting elements are arranged to concentrate their light toward the center of the growing station with which they are associated, while the higher-disposed lighting elements are arranged to produce light more evenly across the entire surface of the growing station.

Additionally, in the illustrative but not necessarily preferred embodiment of FIGS. 1A-1E, the light fixture is circular in the plan view, however, in other embodiments, other shapes may be selected. In certain embodiments, the lighting elements may be constructed of one or more lighting panels assembled to form a helix, each lighting panel constituting a housing for one or more light-producing lamps and their supporting electrical circuitry and connectors. The lighting elements in the light fixture may formed of a plurality of different types of lighting panels (with different size, geometry, light intensity, distribution, and spectra specifications), or they may be formed of a single type of lighting panel (with identical size, geometry, light intensity, distribution, and spectra specifications). Alternatively, different types of lighting elements may be formed by joining together different numbers of identical lighting panels.

An illustrative but not necessarily preferred lighting panel 200 of FIG. 2A may be a modular component to allow for multiple panels to be easily joined together to form a desired lighting configuration. In certain embodiments, a desired lighting configuration of lighting panels may have at least one selected lighting element formed of a single lighting panel. The lighting panels may be uniform in shape and construction to allow a user to customized a lighting configuration. For example, a modular lighting panel 200 may have generally a “sector” (pie-piece-shaped) geometry to provide the lighting elements with uniform length and width. The modularity of the lighting panel 200 allows for construction of lighting elements of varying widths by assembling multiple lighting panels 200 together.

An illustrative but not necessarily preferred lighting fixture 120 of FIGS. 1A-1E may be formed of two different types of lighting elements 122: a first type comprising a single lighting panel 200, and a second type comprising a multiple number of single lighting panels 200 joined together in a plane. The lighting fixture may be formed by joining a selected number of first type lighting elements to construct the helix, and then joining a single second type of lighting element to the first type lighting element at the top of the helix for disposition at the top of the container. As an example of the second type of lighting element, a top lighting element 123t may be assembled by joining multiple single lighting panels 200 in a plane to form a lighting panel that is sufficiently wide to cover the position in the chamber 106 designed to hold the most mature plant in the container.

The size and shape of the lighting panels are at the discretion of the designer and may depend on the amount of light that is required for a selected plant as a selected stage of growth or to accommodate different plant growth patterns. In other embodiments, the lighting panels may have unequal lengths and widths. Unequal-length and width lighting panels may be used to accommodate larger growing stations in the grow tray used in offset or non-circular light fixtures, or to reduce size or weight, or to accommodate plant growth patterns.

In the embodiment of FIGS. 1A-1E, multiple horizontal lighting panels may be used to form the helix; however, in other embodiments, the helix may be constructed from one or more components in any orientation. Further, in order to simplify manufacturing and shipping, the helicoid may be constructed from multiple horizontal lighting panels (as shown in FIGS. 1A-1E); however it may be constructed from a continuous helicoid lighting panel. In other embodiments, for example, unequal-length lighting panels may be used to produce offset or non-circular lighting elements, for example to reduce size or weight, or accommodate plant growth patterns.

Referring to FIG. 1B, the light fixture 120 may have a first lighting element 123c and a second lighting element 123b adjacent to the first lighting element 123c, with first lighting elements 123b, 123c having top surfaces 128b, 128c, respectively, which form stair treads, a side edges 127b, 127c, respectively, which form stair risers. Therefore, when the first lighting element and the second lighting element are consecutively disposed and adjacent on the light fixture, a top edge of one side of the first lighting element is arranged to abut a bottom edge of the other side of the second lighting element, and the edge between the top surface 128c and a first side edge 127c of the first lighting element 123c forms a nosing of a stair. The staggering of adjacent lighting elements along the column 124 from the lighting element closest to the grow tray to the lighting element that has the greatest vertical distance from the grow tray thus forms a helix 126 with a single turn of the spiral of the helix.

In the illustrative but not necessarily preferred embodiment shown in FIGS. 1A-1E, the light fixture 120 has a plurality of lighting elements 122 and a top lighting element 123t as wide as a plurality of lighting panels 200 disposed at the top of the central column 124 above the other lighting panels 200; and the lighting panels 200 are sized and disposed on the central column 124 to ensure that a closed stepped helix of one turn is formed, in which the edge of the first lighting panel forming a nosing of a stair is at or near the edge of the adjacent lighting panel forming a riser.

The illustrative lighting panel 200, as shown in FIG. 2A may be reflective and hold on its bottom surface 285 one or more downward facing lights 280, typically, off-the-shelf LEDs or LED modules. The lighting panel 200 may include ventilation holes 285 through the lighting panel 200 from its bottom surface 295 to its top surface 265 to assist with LED cooling and chamber air flow. The lighting panels 200 may incorporate a transparent safety shield (not shown) below the LEDs to prevent direct contact with the hot LED lenses. Since each lighting panel 200 may be arranged to illuminate a different stage of plant growth, in certain embodiments, lighting panels may be provided with a combination of one or more of the following: unique light intensity, light spectrum, LED configuration, or number of LEDs as appropriate for that stage of growth.

As shown in FIG. 2A, the lighting panel 200 may be generally triangular or sector (pie-piece) shaped, with a ring bracket 284 disposed at or near inner vertices 282 coplanar with the lighting panel and sized to fit over the central column 124. A lighting panel 200 may have may have a bottom surface 285 for holding downwardly facing lights, a first side edge 227 and second side edge 221 extending outwardly along the lighting panel 200 from inner vertices 282 to outer vertices 281. The lighting panel 200 may be stacked with other ring brackets of other lighting panels on the central column 124 through their ring brackets 284 (also known as attaching ring or vertex ring).

The ring bracket 284 may be arranged to stably support the downwardly facing lights on the lighting panel 200 in position over the grow tray when the ring bracket 284 is fit over the central column. The ring brackets may be spread out in a pattern along the column 124 to form the helical stepped ridge of a single turn.

The attaching vertex ring 284 may bear registration markings (not shown) for the cameras (also not shown). The attaching ring 284 may incorporate alignment notches 264 and alignment tabs 294 (as shown in FIG. 2A) to keep the lighting panels in alignment with each other in the helix, with the alignment notch and alignment tabs offset in a lighting panel so that one lighting panel is held in the bracket of the lighting panel adjacent above the one lighting panel and the lighting panel adjacent below the one lighting panel, respectively, when the lighting panels are slipped over the central column 124.

### Equipment Bay

The container 100 may have an equipment bay disposed in the space of the container above the lighting elements and sized to house equipment for use in maintaining the garden. In the illustrative but not necessarily preferred embodiment of FIGS. 1A-1E, an equipment bay 170, particularly shown in FIGS. 1C and 1D, may be disposed in the space of the container directly above the lighting system, reducing the overall size of the enclosure. The equipment bay 170 may be defined by the interior space of the container 100 between the end panel 174, the container cover 104 of the container enclosure, and the outer bay panel 172 (which may rest on top of the light fixture 120 and extends around the interior of the container 100 from the near end of the top lighting element 123t adjacent to the end panel 174 to the far end of the top lighting element 123t above the perimeter of the light fixture 126). Because the illustrative but not necessarily preferred equipment bay 170 is disposed in the container space directly above the lighting system and the floor of the equipment bay coincides with or is directly above the ceiling of the illustrative but not necessarily preferred lighting fixture 120 (which is helicoidal in geometry), the floor of the equipment bay 170 may be helicoidal in geometry to conform to the shape of the light fixture 120, to maximize the volume of the equipment bay 170, and to allow selected spaces in the bay to accommodate items of varying heights.

As noted above, the illustrative but not necessarily preferred container wall panels are shown as flat and, in combination with each other and the vertical supports 105, form a truncated square in plan view, while the illustrative but not necessarily preferred outer bay panel 172, like the light fixture, is circular in plan. Therefore, the equipment bay 170 in cross-section is a truncated square with a circular hole in its middle.

The illustrative but not necessarily preferred end panel 174, which may be vertically disposed at a first radial boundary between the growing station for the plant most nearing readiness for harvest and the growing station for the youngest plant, may cover the end of the equipment bay 170 and fill the gap between the lowest and highest parts of the light fixture and extend from the highest parts of the light fixture down to the grow tray cover 112. The outer surface of the end panel 174 may be reflective to help distribute the light. The end panel 174 may cover the end of the equipment bay and may also be removable to provide access to equipment in the bay.

The illustrative but not necessarily preferred outer bay panel 172 is arranged to cover the area above the lights and serves to separate the airflow above the lights from the airflow below. In other embodiments, the lights extend almost to the container cover 104 and the outer bay panel may begin at the top edge of the end panel 174 and extend to the second radial boundary for the growing station for the plant most nearing readiness for harvest (the radial boundary closest to the growing station for the next most mature plant in the grow tray). The outer bay panel 172 may serve as a safety barrier to isolate the user from the electrical equipment. Further, it may also provide a cosmetic cover for the equipment bay.

The equipment bay 170, also known as an equipment chamber, may house equipment for the operation of the container 100, and components such as a dryer 131, a sprouter 132, an air handling system (also known as the airflow system), a nutrient handling system 220, a control system 140, and a power supply 135. The dryer 131, which may be mounted to the container cover 104, may be arranged to use air provided by the airflow system, described below, to dry mature and harvested plants such as herbs, spices and flowers. The sprouter 132, which also may be mounted to the container cover 104, may be used to provide a warm, dark chamber for sprouting seeds prior to placement under the lighting elements.

### Air Handling: Ventilation, Filtration, Circulation, Drying

Air handling components may be located in the equipment chamber 170. As shown in FIGS. 1C and 1D, the air handling control system may have and control one or more fans, air flow vents, filters, and ducts to provide airflow for ventilation, circulation, and drying.

As shown in FIGS. 1C and 1D, the end panel 174 may have a circulation fan port 492, which is sized to support a circulation fan 192 to circulate air through the chamber. The circulation fan may be a high-volume low-pressure fan. The shape of the container enclosure and the helical geometry of the light fixture shown in the illustrative but not necessarily preferred embodiment of FIGS. 1A-1E are arranged to direct air in a circular manner within the chamber, so a static fan may be used instead of an oscillating fan, increasing reliability, reducing cost, space, and power. In certain embodiments, the circulation fan may circulate air in a direction that is opposite to the direction of rotation of the plants relative to the lights. For example, in the illustrative embodiment of FIGS. 1A-1E, in which the plants rotate clockwise relative to the lighting elements, the circulation fan may circulate air in a counter-clockwise direction.

An exhaust fan 194, may be mounted to the container cover 104. The exhaust fan 194 may be a low-volume high-pressure fan for drawing air through the lighting panels 200 and pushing the exhaust air through an exhaust filter 196, which may be mounted to the container cover 104. The exhaust fan 194 may create negative air pressure in the chamber 106 for providing cooling for the lights, power supply and computer, ventilation for the plants, and filtration to reduce odors. Specifically, the exhaust filter 196, which may be disposed between the exhaust fan 194 and an exhaust fan port 198, may be a disposable activated carbon air filter that may be replaced with other consumables as part of a supplies subscription plan. In other embodiments the filter may be placed before the exhaust fan, which will pull the air through the filter.

The location of the end panel 174 between the lowest part of the helix and the highest part of the helix may block or impede air flow within and around the helix, so one or more air flow vents such as the circulation fan port 492, for the circulation fan 192 may be disposed in the end panel to promote ventilation and circulation of air within the chamber 106, allowing air to be moved in a circular manner within the chamber. One or more air filters may also be disposed for odor control. One or more filters may also be disposed for the circulation fan 192. The air handling system may also include sensors (not shown) disposed in the chamber 106 for sensing environmental conditions such as humidity, CO2 levels, and/or temperature to be used by a controller to control the fan(s).

The air handling system may also be arranged for use in a temperature-controlled environment. Further, the air handling system may be arranged to supply heating and/or cooling for other environments. The air handling system may also have spot infrared equipment in order to customize heating to benefit specific stages of plant growth.

### Nutrient Handling: Transfer, Circulation

In certain embodiments, the container 100 may have a nutrient handling system 220 having one or more pumps and zero or more valves, which may be solenoid-controlled. The nutrient handling system 220 may be configured to transfer and circulate the nutrient solution, transferring the nutrient solution between the nutrient tank 224 and the grow tray 110, and circulating the solution while it is in the grow tray 110. As shown in FIGS. 2D and 2E, the system 220 may have a nutrient tank 224 contained within the central column 124 and a valve assembly 240 disposed under the nutrient tank and connected to the nutrient tank through a tank opening 225, which may operate as an inlet and an outlet for fluids stored in the tank 224. In other embodiments, a nutrient tank 224 may have separate openings to operate as an input and an outlet, respectively.

As shown in FIG. 2E, the valve assembly 240 may have a fill valve 244, which may be arranged to control the flow of fluid into the nutrient tank 224, and a drain valve 246, which may be arranged to control the flow of fluid out of the nutrient tank. One terminal of each valves 244, 246 may be connected to each other and to the nutrient tank opening 225 by a T-pipe 258. In the embodiment of FIG. 2E, the terminal of the fill valve 244 that is attached to the tank constitutes a fill valve output; and the terminal of the drain valve 246 that is attached to the tank constitutes a drain valve input.

The other terminal of the fill valve 244, which may constitute a fill valve input, may be connected to a first end of a T-pipe 254, which is connected at a second end to an outlet of a pump 232. An inlet of the pump 232 may be connected to a pipe 233 with an inlet 234 disposed within the plant bed of the grow tray. Thus, the pump 232 may be arranged to suction fluid from the plant bed of the grow tray 110 through the inlet 234 of the pipe 233 to the pump 232, and then to push fluid though the fill valve 244 and into the nutrient tank 224.

The other terminal of the drain valve 246, which may constitute the drain valve output, may be connected to a first end of a T-pipe 256, which has an outlet 236 at a second end that is disposed within the plant bed of the grow tray. Thus, the drain valve 246 may be arranged to allow fluid from the tank 224 to pass therethrough and to be discharged into the plant bed of the grow tray 110 through the outlet 236 of the T-pipe 256.

The valve assembly 240 may also have a circulation valve 248 arranged to allow recirculation of the nutrient fluid within the grow tray 110. The circulation valve 248 may be connected between the third ends of the T-pipes 254, 256, with the T-pipe 254 thus connecting the input of the fill valve 244, the outlet of the pump 232, and the input of the circulation valve 248; and with the T-pipe 256 thus connecting the output of the drain valve 246, the output of the circulation valve 248, and the interior of the plant bed of the grow tray 110 through the outlet 236 of the T-pipe 256.

In operation, releasing fluid from the nutrient tank into the plant bed may be initiated by a controller issuing instruction signals to the drain valve 246 to open the drain valve to release the fluid from the nutrient tank. The fluid may be gravity fed through the drain valve 246, through the T-pipe 256, and into the grow tray. The controller may also issue instructions to shut off the pump 232, and to close the circulation valve 248 and fill valve 244 so that no fluid passes through the components 232, 244, 248 or remains stagnant in the pipes of the fluid handling system 220. The drain valve 246 may remain open for a selected period of time, with the time selected to allow all of the fluid to drain from the tank. In certain embodiments, the nutrient tank may have a sensor to determine when the tank is empty. In certain other embodiments, the grow tray may have a sensor to determine when the tray is full. In other embodiments, the period of time in which the components 232, 244, 248 are closed and the drain valve 246 is open may be set by a user based on inspection of one or more initial tank drainings.

Pumping of fluid from the grow tray to the nutrient tank may be initiated by a controller issuing instruction signals to the fill valve 244 and the pump 232 to open the fill valve and activate the pump to pull fluid from the grow tray through the pipe 233 to the pump 232, and then push the fluid from the pump through the fill valve 244 to the nutrient tank. The controller may also issue instructions to close the circulation valve 248 and drain valve 246 so that no fluid passes through them and is fed back into the grow tray. The pump and fill valve may remain active and open for a selected period of time, with the time selected to allow all of the fluid to drain from the grow tray. In certain embodiments, the nutrient tank may incorporate a sensor to determine when the tank is full. In certain other embodiments, the grow tray may have a sensor to determine when the tray is empty. In other embodiments, the period of time in which the components, 246, 248 are closed and components 232, 244 are open may be set by a user based on inspection of one or more tray drainings.

Circulation of the fluid in the grow tray may be initiated by a controller issuing instruction signals to the circulation valve 248 and the pump 232 to open the circulation valve and activate the pump to pull fluid from the grow tray through the pipe inlet 234 to the pump, and then push the fluid from the pump through the circulation valve, through the pipe 256 to its outlet 236 and into the grow tray. The controller may also issue instructions to the drain valve 246 and fill valve 244 so that no fluid passes through them to the output of the pump or remains stagnant in the pipes of the fluid handling system 220. The pump and fill valve may remain active and open for a selected period of time, with the time selected to allow the plants to absorb the nutrients in the fluid.

In certain embodiments, the fluid handling system 220 as described above may be operated using an ebb and flow cycle in which nutrient fluid is transferred from the nutrient tank to the grow tray, circulated in the tray for a period of time, then pumped back to the tank to hold for a selected period of time. In one embodiment shown in FIG. 2F, the ebb and flow cycle 270 may have:
a fluid flood stage 272 (in which fluid is transferred from the tank into the tray by pumping, for example, when the tank is below the tray, or by gravity feed, for example, when the tank is above the tray);
a fluid circulation stage 274 (in which fluid is circulated for a selected period of time from tray to pump to tray);
a fluid draining stage 276 (in which fluid is transferred from the tray to the tank) by gravity feed, for example, when the tank is below the tray, or by pumping, for example, when the tank is above the tray); and
a system rest stage 278 (in which the grow tray remains empty of fluid and the fluid and nutrient handling system components are allowed to remain at rest for a selected period of time).
   The fluid handing cycle may then be repeated with a frequency that may be chosen by the designer, or, in certain embodiments, by the user. In one embodiment, the ebb and flow cycle may be repeated multiple times daily and may be repeated indefinitely.

In one illustrative but not necessarily preferred embodiment, the duration of each of the stages of the ebb and flow cycle is set so that each stage takes a fixed (not necessarily identical) period of time. In further embodiments, the duration of the fluid release and fluid draining stages is selected to be sufficient to allow the fluid to transfer into and out of the grow tray, respectively. In further embodiments, the circulation and system rest stages, the delay may be selected to be longer than in the period spent in the fluid release and fluid draining stages. In one but not necessarily preferred embodiment, the cycle remains in the system rest stage for most of the duration of the cycle, allowing the grow tray to be empty of fluid for most of the time spent in a cycle. In certain embodiments, the lengths of the periods for the stages and the frequency of repetitions may be built into the system by the system designer; in other embodiments, they may be definable manually by the user or programmed, definable by the user using software, and controllable by a computer.

One advantage of implementing an ebb and flow operation is that plants undergoing growth in the grow tray are provided a nutrient delivery cycle that is optimal for growth. When the grow tray 110 is empty, the root systems of the plants are exposed to the air, allowing oxygen, which is an essential nutrient for plant growth, to be absorbed easily through the roots; when the grow tray is full of nutrient fluid, which holds other essential nutrients, the roots are bathed in the fluid and absorb the other nutrients.

The nutrient handling system 220 may be operated by a movement controller, not shown. When the pump is stationary, nutrients may be transferred to/from the center of the grow tray or, in certain embodiments, via a rotating union, which allows fluids to move between a stationary tank and a rotating grow tray. Alternatively, the pump may rotate with the tray. In certain embodiments, the nutrient handling system may be solar powered; and it may be controlled wirelessly.

### CO2 Enrichment System

The container gardening system may also have a carbon dioxide (CO2) enrichment system (not shown), for supplying carbon dioxide to the plants undergoing growth in the container 100. The CO2 enrichment system may include a CO2 tank and a computer-enabled valve. As noted above, the CO2 enrichment system may also incorporate a CO2 sensor.

### Operation

### Relative Rotation of Plants and Light Fixture

In operation, the container 100 supports the growth of plants at different stages of growth to allow for a more efficient, more continuous availability of plants ready to harvested. The continuous growth container as contemplated in the current invention is arranged to operate continuously to grow plants, but require interaction by a user only periodically. The container 100 may have a grow tray arranged to hold growing plants that are disposed in the grow tray at stages of increasing growth. As noted above, the plants may be arranged to rotate around the growing chamber relative to a light fixture having a plurality of lighting elements disposed in space above the grow tray and arranged to radiate light to the plurality of growing plants such that, for a selected plant in the grow tray, the light radiated to the selected plant from a lighting element above the selected plant is optimal for the selected plant's stage of growth. As the plants grow taller, the plants may be arranged to move relative to the light fixture to ensure that light radiated to the plants is optimal for the plants' stages of growth.

In certain embodiments, the plurality of lighting elements may be disposed in space above the grow tray at increasing distances from the grow tray, with the distances selected to ensure that, for a selected plant in the grow tray, a distance between the lighting element directly above the selected plant to the selected plant is optimal for the selected plant's stage of growth. As the plants grow taller, the plants may be arranged to move relative to the light fixture to ensure that the distances between the plants and the lighting elements are optimal for the plants' stages of growth.

As the plants grow taller, the plants may be arranged to move relative to the light fixture to maintain the distance between the plants and the lights and the light intensity that is optimal for the selected plant's stage of growth.

The positions of the light fixture and plants are arranged to change relative to each other (either through movement of the grow tray or movement of the lighting fixture). In certain embodiments, their positions may be changed relative to each other using a series of small frequent movements so that rotation of plants relative to the lights appears to occur relatively continuously. In other embodiments, their positions may be arranged to change relative to each other in response to the growth of the plants such that, at a selected stage of plant growth, the movement of plants relative to lights may occur in large discrete rotations to move the plants from lighting panel to lighting panel to increase the distance of the grow tray from the lighting fixture. As the plants and light fixture move relative to each other, the station height of a selected growing position in the grow tray increases until the distance between light fixture and grow tray at the selected growing position reaches a maximum station height.

As noted above, the helicoidal shape of the illustrative but not necessarily preferred light fixture 120 allows for station heights disposed radially around the grow tray to accommodate the heights that plants in the growing station are expected to reach beneath the lights, starting with a minimum station height comprising a shortest light fixture/grow tray station height intended to bring the lighting fixture closest to the seedlings, which are the youngest plants, in a plant growing position in the grow tray, and continuing with increasing station heights until the distance between light fixture and grow tray reaches a maximum station height arranged to accommodate the heights of plants nearing harvesting readiness.

In either case, the grow tray, which may be generally circular in cross-section, is arranged to hold plants of monotonically increasing maturity (and therefore of monotonically increasing height) around the grow tray such that plants of increasing height may be disposed around the grow tray, from shortest to tallest and, due to the circular cross-section of the grow tray, with the tallest plants adjacent to seedlings (or, in certain embodiments adjacent to a grow tray region that is empty due to the plants therein recently having been harvested).

After movement of the lighting elements and plants relative to each other, the height of a selected growing station increases. Therefore, in response to the plants entering a new stage of growth (as determined by a gardener's visual inspection of the plants, or as determined by sensors and controls, not shown, that a plant or plants have entered a new phase or stage of growth), the plants are disposed (manually, through a motor's operation, or automatically) under a lighting element that is optimal for their new stage of growth. In further embodiments, the relative movement occurs automatically, with motorized controls or computer-enabled control, based on the expected maturation period of the plant being grown and the number of desired movements of the plants relative to the lighting elements. Further, the frequency of movements may be near-continuous or based on the width of lighting elements or growing stations.

In the embodiment of the container shown in FIGS. 1A-1E, changing positions of the light fixture and plants relative to each other is accomplished by rotating the grow tray. In the embodiment of the container 100 in FIGS. 1A-1E, the grow tray is disposed on a rotatable base and the light fixture disposed above the grow tray with lighting elements arranged around the light fixture to radiate light to the grow tray and around the top surface of the grow tray. The lighting elements are arranged along one turn of a helix on the light fixture so that distance from lighting elements to the tray increases at selected adjacent locations around the grow tray. The plants may be arranged to move relative to the light fixture, so that more mature plants are disposed on the grow tray at increased distances from the lighting elements on the light fixture. Thus, the grow tray will contain along its length plants of increasing maturity, from most immature (at the lowest distance between the grow tray and lighting elements on the light fixture) to most mature (at the highest distance between tray and lighting element).

### Cultivation Cycles

In order to supply a continuous harvest of plants, a container 100 may be operated in conformance with a defined cultivation cycle. The nature of the cultivation cycle may be defined at the discretion of the container system designer, but in general, the cultivation cycle may contain phases in which the most mature plant or plants (those ready to be harvested) are removed from the grow tray, seedlings or seeds placed in an empty growing station, the plants moved relative to the light fixture in the direction of increasing plant maturity so that the plant receives increased height in their section of the growth chamber, and the plants in the grow tray undergo a new stage of growth in their new positions under the light fixture.

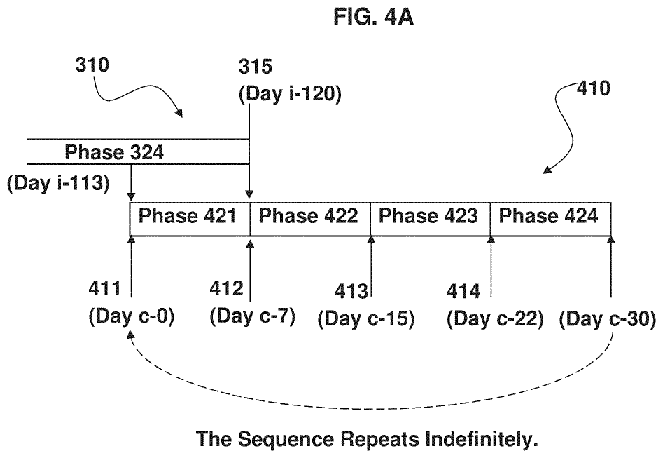

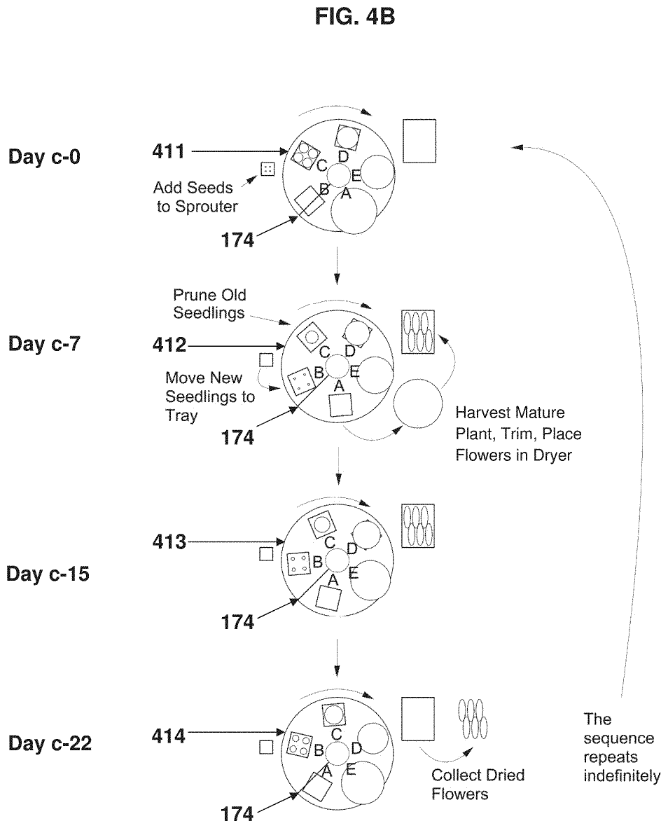

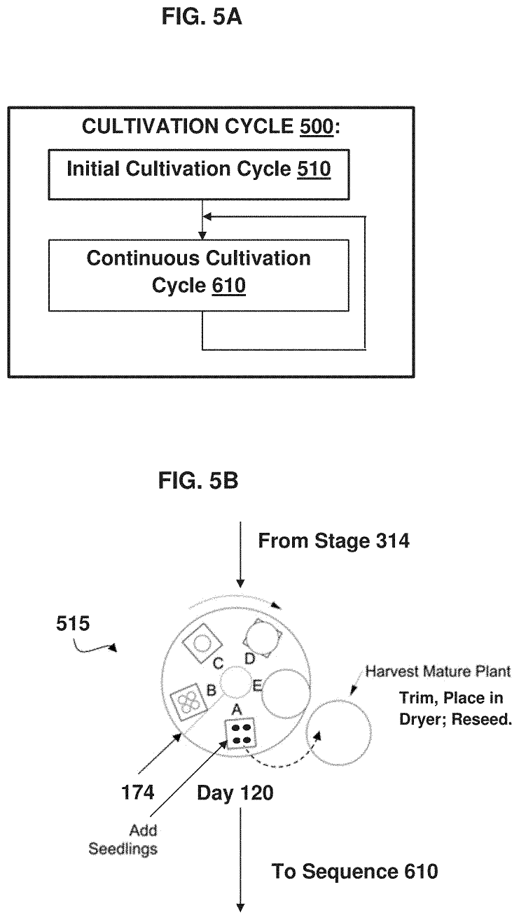

In certain embodiments of cultivation cycles, such as cultivation cycle 300, shown in FIGS. 3A-4B, once the mature plants have been harvested, the grow tray may contain two empty growing stations—one that had just undergone harvesting and the one that had undergone harvesting most recently (one position away on the grow tray from the growing station that had just undergone harvesting); and the growing station that had undergone harvesting previously may be replanted with seeds/seedlings at or near completion of harvesting while the growing station that had just undergone harvesting may remain fallow for a cultivation cycle phase. One advantage to leaving a growing station fallow for a phase is that the plant that is most mature in the grow tray after harvesting has been performed has additional space in the chamber about its growing station to spread out and grow to its maximum capability. Another advantage is that the end plate may extend all the way down to the grow tray cover 112 with minimal clearance, in order to separate the airflow on each side of the plate. In other embodiments of cultivation cycles, such as cultivation cycle 500, shown in FIGS. 5A-6, described below, the empty growing station—the one from which the mature plant is harvested—may be replanted with seeds/seedlings at or near completion of harvesting. One advantage to cultivation cycle 500 is that more plants are being grown in the grow tray, leading to greater overall harvesting. Cultivation cycle 500 may be optimal for plant types that have relatively smaller circumferences at maturity. However, care must be taken to ensure that the lighting elements provide sufficient light and that the bottom edge of the end panel 174 of the equipment bay leaves sufficient space for the seedlings in the freshly planted growing stations to fit thereunder.

Before continuous harvesting may begin, the growing stations of the grow tray may undergo an initial cultivation sequence, also known as an initial sequence, in which the growing stations are supplied with plants in increasing stages of growth, starting with a first growing station having the youngest plants, which may be seeds or seedlings, and ending with a last growing station with the most mature plant, nearing or ready for harvesting. The stages of plant growth may increase in the grow tray in a direction around the grow tray that is the direction of movement of the plants relative to the light fixture, selected for example by the designer or user. In the embodiment described above and shown in FIGS. 1A-1E, the plants in the grow tray increase in stages of growth around the grow tray in a clockwise direction.

The plants may be introduced into the growing stations in any conventional manner, such as, in certain embodiments, by a user planting purchased plants by height along the grow tray from first to last growing station. In another illustrative but not necessarily preferred embodiment, an initial sequence of plant growth may be followed in which plants are introduced over time into the grow tray as seeds or seedlings until the growing stations of the grow tray are filled to the capacity determined by the initial sequence.

After the initial sequence, a continuous cultivation sequence, also known as a continuous sequence, may be followed in which the plants are moved relative to the light fixture and, after one growing station is harvested of a mature plant, another growing station is replenished with new seeds/seedlings.

In either plant replenishment type, as the plants grow, the grow tray may be rotated (or the lighting fixture may rotate) so that the growing stations in the grow tray are now associated with lighting elements at an increased distance from the grow tray in order to promote optimal growth of the new plant(s) in the new stage of plant growth.

So long as mature plants are harvested, new plants are introduced into empty growing stations, nutrients are provided to the growing plants as needed, and the plants are moved relative to the light fixture so that the plants receive increased height in their respective sections of the growth chamber, the phases of a continuous cultivation sequence may be repeated to supply a continual harvest of plants.

Cultivation Cycle 300

As shown in FIG. 3A, one illustrative but not necessarily preferred cultivation cycle 300 has an initial cultivation sequence 310 and a continuous cultivation sequence 410 to support a periodic but continual harvest of plants. In cycle 300, the grow tray may contain two empty growing stations—one that had just undergone harvesting and the one that had undergone harvesting most recently (one position away on the grow tray from the growing station that had just undergone harvesting).

The illustrative but not necessarily preferred embodiment of a cultivation cycle 300 is based on a 120-day maturity period that extends from planting a seedling to the plant reaching a harvesting-ready maturity. The alternative cultivation cycle that starts with planting a seed rather than a seedling (for example, a cultivation cycle in an embodiment in which the gardening container does not have a sprouter or when the user chooses not to use a sprouter) has a greater number of number of days in its associated maturity period, with the number of days in the maturation period adjusted upward to include the amount of time required for seeds to sprout into seedlings. If the sprouting period is sufficiently short (for example, if it is only a few days long), the maturation period need not be adjusted. In other embodiments in which the type of plant undergoing growth has a different maturation period, the number of days in phases of the initial sequence may be adjusted upward or downward to accommodate the plant type's different maturation period.

Initial Sequence 310

One illustrative but not necessarily preferred initial sequence is shown diagrammatically in FIGS. 3B and 3C, in which seedlings may be periodically introduced to the growth chamber until all of the plant positions, except one, are occupied. The initial cultivation sequence supports multiple phases of plant growth. FIG. 3B illustrates growth of a plant having a maturation period of 120 days undergoing growth in the container, with four phases 321, 322, 323, 324 having periods of 30 days each to accommodate the 120-day maturation period of the plants undergoing growth in the container. FIG. 3B shows five states 311, 312, 313, 314, 315 that represent the condition of the grow tray with five growing stations A, B, C, D, E at Day i-0, i-30, i-60, i-90, i-120, respectively, of the 120-day maturation period respectively,
with State 311 occurring on Day i-0 (the first day of the phase 321),
with State 312 occurring on Day i-30 (the first day of the phase 322).
with State 313 occurring on Day i-60 (the first day of the phase 323),
with State 314 occurring on Day i-90 (the first day of the phase 324), and
with State 315 occurring on Day i-120 (the last day of the initial cultivation sequence 310).

The initial sequence 310 may be used in conjunction with the container 100 disclosed above, with FIG. 1B showing an example of the arrangement of lighting elements and growing stations that maybe used to support the contemplated operation of a growth container in FIG. 3B. In certain embodiments, the light fixture has the same number of lighting elements as the container's growing stations, but in the embodiment shown in FIG. 1B, the light fixtures have multiple lighting elements per growing station, so that the light fixture operates to provide a more continuous radiation of light to the container's grow tray, with increasing distance of the light from the stations in the grow tray along the grow tray.

FIG. 3C shows the starting state 311 of the grow tray at Day i-0 of the phase 321 in the initial cultivation sequence 310 for the container 100 (before continuous harvesting begins). In a Day i-0, seedlings may be planted in the growing station A, which is located under one or more lighting elements that are closest to the grow tray so that the light radiated from the lighting element(s) is optimal to support the growth of new plants. In addition, in embodiments in which the container gardening system has a sprouter such as sprouter 132 as shown in FIG. 1D, a user may load the sprouter 132 with seeds at an earlier time to prepare for the initial sequence and then load the growing station A with seedlings from the sprouter 132. In such embodiments, when the user removes seedlings from the sprouter 132 to load a growing station, the user may replenish the sprouter 132 with seeds to ensure that the sprouter 132 maintains a sufficient supply of seedlings for future growing station loadings.

Throughout the initial sequence, the grow tray may rotate as the plants grow taller. The speed of rotation and direction of rotation will be at the discretion of the container designer. In certain embodiments, the grow tray may slowly rotate as the plants grow taller. In other embodiments, when the plants grow taller, the grow tray or light fixtures may be advanced to provide more station height for the growing plants. However, the rotation is performed (manually, motorized, or automatically), the grow tray and lighting fixture may be moved in the direction that allows more station height to be provided to the growing plants. As illustrated in the container 100 shown in FIGS. 1A-1E, the grow tray may be rotated in a clockwise direction and the speed of rotation may be slow, on an average of 2.4°/day.

In container gardening of plants with a maturation period of 120 days such as in the embodiment shown in FIG. 3B, a fresh batch of new seedlings may be introduced into a new growing station on Day i-0 and every 30 days thereafter, with:
the state 312 showing growing station E planted at Day i-30, the first date of the phase 322;
the state 313 showing growing station D planted at Day i-60, the first date of the phase 323;
the state 314 showing growing station C planted at Day i-90, the first date of the phase 324; and
the state 315 showing growing station B planted at Day i-120, the last date of the initial cultivation sequence 310.

It can be seen that planting may occur in the grow tray in the phase in the above-identified sequence at the associated growing station that, due to the movement of the plants relative to the light fixture, is located under the set (one or more) of the lighting elements that are closest to the grow tray so that the light radiated from the lighting element(s) is optimal to support the growth of new plants. Thus, seedlings may be periodically introduced to the grow tray until all of the growing stations are occupied. When the oldest plant reaches maturity, the container 100 will hold a sequence of plants of increasing maturity, and will be ready to begin continuous production.

During the initial sequence 310, the user may also choose to thin the number of plants in the growing station A, leaving a fewer number of immature plants undergoing growth in the growing station, at a time or phase determined by the gardener. In certain embodiments, the thinning may be performed on the plants at a single phase of plant growth or time after planting. For example, in the disclosed illustrative but not necessarily preferred embodiment, plants may be thinned from the growing station which is adjacent to the newly planted growing station thirty days after the seedlings are planted (which corresponds to Day i-30, the first date of the phase 322). In other embodiments that may have a different growing pattern, the thinning may be delayed until a later time or phase, such as in 60 or 90 days after seedling planting. Also, in certain embodiments, the performance of thinning also may involve moving the remaining plant to the center of its growing station.

In a state 315 of the grow tray, which constitutes the end point of the initial sequence 310, at Day i-120, the station B is loaded with seedlings, and the plant in station A, which has reached maturity, may be harvested and processed, such as trimmed. In embodiments in which the container gardening system has a dryer such as dryer 131 as shown in FIG. 1D, a user may load the dryer 131 with the trimmed harvested plant.

When the plant in station A has reached maturity and been harvested, the initial cultivation sequence 310 may end.

Continuous Cultivation Sequence 410

When the initial sequence 310 has been completed, a continuous cultivation sequence may be performed repeatedly and indefinitely so as to operate the container continuously with periodic but minimal interaction by the user. In certain embodiments, the continuous cultivation sequence may be a multi-phase sequence in which the growing stations are harvested and planted periodically and in turn while the container undergoes relative movement of the plants and light fixture to allow for plants to mature and be harvested on a rotating basis.

In one embodiment, a continuous cultivation sequence 410, which may also be known as a harvest interval, may involve the following operations:
Before harvest (typically 1-2 weeks in advance):
   If a sprouter is to be used for future planting, one or more seeds may be placed in the sprouter.
Harvest:
   The most mature plant, which is planted in the growing station that is under the highest part of the light fixture, may be removed and trimmed.
   If the harvested plant is to be dried, it may be placed in the dryer.
   Seedlings may be removed from the sprouter.
   One or more seedlings may be placed in the empty growing station under the lowest part of the light fixture, with the empty growing station being adjacent to the growing station from which the mature plant was harvested.
   The growing station adjacent on the other side of the growing station in which the seedling(s) have been planted contains one or more immature plants. If such growing station contains multiple seedlings, the user may thin the seedlings in such growing station so that only one immature plant remains. The remaining immature plant may be moved to the center of such growing station.
   When the container is arranged to host a hydroponic garden, the fluids in the nutrient tank 224 may be replaced or replenished, and the filters in the container may be replaced. In certain embodiments, the fluids and filters are not necessarily replaced at every phase, which in continuous cultivation sequence 410 could be monthly. Instead, the fluids and filters may be replaced as needed.
After harvest (typically 2-4 weeks subsequently):
   Plants in the dryer may be removed when sufficiently dry.
      In addition, when the container is arranged to host a hydroponic garden, the user may replenish the fluids in the nutrient tank 224 as needed at any time throughout the harvest interval. Further, when the container is arranged to host a conventional soil (non-hydroponic) garden, the user may water the garden as needed at any time throughout the harvest interval.

FIGS. 4A-4B contain diagrammatic views of an illustrative but not necessarily preferred embodiment of the multi-phase harvest interval 410 (also known as the continuous cultivation sequence 410) for growing and harvesting plants having a 120 day maturation period in a gardening container such as container 100. FIG. 4A illustrates four phases 421, 422, 423, 424 having periods of 7 or 8 days each. FIG. 4A shows four states 411, 412, 413, 414 that represent the condition of the grow tray of the container with five growing stations A, B, C, D, E, respectively, during one operation of the continuous cultivation sequence 410.

FIG. 4B illustrates more detail of the continuous cultivation sequence 410, which is operated after the operation of the initial sequence 310 shown in FIG. 3B. The initial sequence 310 is designed for growing plants having a 120-day plant cultivation cycle, so the continuous cultivation sequence 410 is designed to accommodate a 120-day plant cultivation cycle. In other embodiments, in which the initial cultivation sequence has been adjusted upward or downward to accommodate the maturation period for a plant of a different type, the number of days in phases of the continuous cultivation sequence associated therewith are similarly adjusted upward or downward to accommodate the different plant type's maturation period. Returning to the continuous cultivation sequence 410, the movement of the grow tray and lighting fixture may be performed as conducted in the initial sequence 310, with the grow tray or lighting fixture moving in the direction that allows more station height to be provided to the growing plants. As illustrated in the container 100 shown in FIGS. 1A-1E, the grow tray may be rotated in a clockwise direction fixture at a speed of an average of 2.4°/day.

As shown in FIG. 4B, the operation of the continuous cultivation sequence 410 starts with the growing stations positioned relative to the light fixture such that growing station A is positioned directly under the end panel 174 and ends with the growing stations positioned relative to the light fixture such that growing station E is positioned below the approaching edge of the end panel 174, with continued rotation bringing the growing station E more directly under the end panel 174.

The operation of the continuous cultivation sequence 410 thus represents the movement of the growing stations relative to the light fixture and the user interaction associated therewith during only one 30-day period, which is the same number of days in a single phase of the phase of the initial sequence 310. Therefore, each of the phases of the continuous cultivation sequence 410 represent a quarter of the relative growing stations/light fixture movement and associated user interaction of one phase of the initial sequence 310. In this embodiment, each state 411, 412, 413, 414 represents a seven to eight-day duration, for a total of 30 days. Therefore, the grow tray rotates 18 degrees per phase, for a total of 72 degrees for all four phases.

The illustrative but not necessarily preferred embodiment shown in FIGS. 4A-4B shows a starting state 411 of the grow tray that may commence about one week before the initial sequence state 315 shown in FIGS. 3B, 3C. The start date of the first operation of the continuous cultivation sequence is selected at the discretion of the designer or the user, taking into account the growing requirements of the plants undergoing growth and desires of the user(s), such as the maturation period of the plants, the amount of time it takes for the plants' seeds to sprout in the sprouter, the length of time that such seedlings are survivable in the sprouter, and the amount of intended harvest. The illustrative but not necessarily preferred embodiment shown in FIGS. 4A, 4B show the start (Day c-0) of the continuous sequence 410 (in which the growth of the plants is shown in the starting state 411) occurring at approximately day 113 of the initial cultivation sequence 310 to allow the state 315 of the initial cultivation sequence 310 to correspond to state 412 at the beginning of phase 422 in the first operation of the continuous cultivation sequence 410.

FIG. 4B shows four states 411, 412, 413, 414 that represent the condition of the grow tray with five growing stations A, B, C, D, E at Day c-0, c-7, c-15, c-22, respectively, of the 30-day continuous cultivation sequence 410 respectively,
with State 411 occurring on Day c-0 (the first day of the phase 421),
with State 412 occurring on Day c-7 (the first day of the phase 422),
with State 413 occurring on Day c-15 (the first day of the phase 423),
with State 414 occurring on Day c-22 (the first day of the phase 424), and
with Day c-30 signaling a re-start of the continuous cultivation sequence 410 (Day c-0, the first day of the phase 421).

In the phase 421 (at state 411, Day c-0) of the continuous cultivation sequence 410, or if a sprouter is being used, one or more seeds may be placed in the sprouter. In the phase 422 (at state 412, Day c-7), the most mature plant in the grow tray, which is planted in the growing station A, which is under the highest part of the light fixture, may be harvested from growing station A. The plant may be trimmed and its flowers may be placed in the dryer. Also, when the container is arranged to host a hydroponic garden, the nutrient solution is completely replaced periodically in order to ensure an adequate level of nutrients in the fluid. In certain embodiments, the nutrients are replaced monthly. In the phase 422 (at state 412, Day c-7), the user may replenish the fluids in the nutrient tank 224 and replace the filters in the container as needed.

Further, one or more seedlings may be planted in the empty growing station under the lowest part of the light fixture and which is adjacent to the growing station from which the mature plant was harvested. In the first operation of the sequence 410 shown in the embodiment of FIG. 4B, the empty growing station that is planted in phase 422 (at state 412, Day c-7) is the growing station B. In addition, a user may thin the immature plants in the growing station C, which is adjacent on the other side of the growing station B so that only one immature plant remains in station C. The remaining immature plant may be moved to the center of the growing station C.

In the embodiment of FIG. 4B, in the phase 423 (at state 413, Day c-15) of the continuous cultivation sequence, no user interaction is scheduled. In the phase 423 (at state 414, Day c-22) of the continuous cultivation sequence, the dryer may be emptied of the dried plants. At the end of the phase 424 (Day c-30), the first operation of the continuous cultivation sequence 410 may end, and the second operation of the continuous cultivation sequence 410 may begin at phase 421 (at state 411, Day c-0). The continual sequence 410 may be repeated indefinitely to operate the container system continuously to produce a mature plant every harvest interval, so long as necessarily periodic interaction of the user is performed.

It can be seen that a first operation of the continuous cultivation sequence 400 may be performed as shown in FIG. 4B, in which the growing station B is positioned directly under the end panel 174. However, a review of FIG. 4B with the recognition that the sequence 410 is operated continuously, shows that the second operation of the continuous cultivation sequence 400 starts with the growing station A (not B) directly under the end panel 174. Therefore, when viewing FIG. 4B as illustrative of the operation of subsequent continuous cultivation sequence 410, with each repetition of the continuous cultivation sequence 410, the grow tray/light fixture rotation causes the growing stations to be shifted by one station in the representations of the sequence shown in FIG. 4B. Therefore, the third, fourth, and fifth operation of the continuous cultivation sequence 410 start with the growing stations E, D, C, respectively, directly under the end panel 174, while the sixth operation of the continuous cultivation sequence 410 may be seen to be illustrated as exactly shown in FIG. 4B, in which the growing station B is directly under the end panel 174.

Cultivation Cycle 500

As shown in FIG. 5A, one illustrative but not necessarily preferred cultivation cycle 500 has an initial cultivation sequence 510 and a continuous cultivation sequence 610 to support an alternative periodic, continual harvest of plants. The cultivation cycle 500 may be defined to differ from the cultivation cycle 300 in that, when a plant is harvested, the growing station from which the plant is harvested is not left empty. Instead, immediately after harvesting the mature plant, seeds or seedlings may be planted in the newly emptied growing station.

With the above-described modification in planting strategy, the duration of growing phases and placement of lighting elements in the light fixture may need to also be modified. In addition, the end panel 174 may be raised a selected height above the top surface of the grow tray to allow the growing seedlings to pass thereunder upon movement of the growing stations relative to the lighting elements.

The cultivation cycle 500 may be useful in embodiments in which seeds rather than seedlings are planted in the grow tray. The height between the top surface and the bottom of the end panel may not need to be adjusted (or only minimally adjusted) to accommodate the height of seedlings. In addition, the increased maturation period (to allow the seed to grow into a seedling) may not require a change in the speed of movement of the growing stations relative to the lighting elements, as the seeds may require less intense light to thrive and the light being provided to the seeds in the growing station from which the plant had just been harvested, having the maximum light fixture/grow tray station height associated therewith, receives the weakest amount of light in the growth chamber. Therefore, the seeds may have sprouted into seedlings by the time that the growing station into which seedlings would be planted according to cultivation cycle 300 is positioned under the lighting elements that are the shortest distance from the grow tray. For seeds that sprout into seedlings best in darkness, the growing station carrying the seeds may be covered with a shield until the seedlings emerge.

Initial Cultivation Sequence 510

The initial sequence 510 may be selected to encompass the phases 321-324 of the initial sequence 310, with a replacement of state 315 with a state 515 as shown in FIG. 5B.

As with the state 315, the state 515 may be the last state of the grow tray, which, as with the sequence 300, is arranged to continually harvest plants with a 120-day growth cycle. In the state 515, as with state 315, the plant in station A, which has reached maturity, may be harvested, processed, and loaded in to the dryer 131 with the trimmed harvested plant. In the state 515, the growing station from which the plant has been harvested is then prepared for re-planting or re-seeding, and then re-planted or re-seeded. The initial sequence 510 may then end.

Continuous Growth Sequence 610

It can be seen that the container gardening container disclosed herein supports growth of plants at different and increasing stages of growth. The container gardening container 100 may be operated to produce a rolling harvest of crops, providing a more frequent harvest of crops than would be available should all plants in the container be planted at the same time. When the initial sequence 510 has been completed, a continuous cultivation sequence 610 may be performed repeatedly and indefinitely. The sequence, which may also be known as a harvest interval, may have phases that are similar to the phases in the continuous sequence 410, with harvesting, supply replenishments, and re-planting or re-seeding scheduled according to the growing requirements of the selected type of plant, with the exception that a growing station from which a plant has been harvested is re-planted or re-seeded upon harvesting.

### User Interaction

It may be seen that, while the disclosed container gardening structure 100 may be operated continuously, the user may interact with it only periodically. As the plants grow taller, the grow tray rotates to maintain an optimal distance between the plants and the lights, and the user performs certain tasks to manage the operation of the disclosed container gardening structure 100.

As noted above, a plant has a maturation period specific to its type. For example, a plant may have a maturation period of 120 days; however, the variance in maturation periods for other types of plants may be wide. In the initial cycle of cultivation (for example, for the exemplary type of plant, for the first 120 days), there will be no mature plants to harvest, but once the first plant reaches maturity, and once a cultivation cycle has been established in which plants are undergoing growth in the container at different and increasing stages of growth, crops may be harvested at a growing station at each phase.

In addition, a user may place the seeds in the sprouter at any time that is appropriate to the plant type's sprouting period. When seeds from which the plants are grown sprout more quickly than the duration of a phase in a cultivation sequence, a user may place the seeds in the sprouter later in the cultivation sequence. Further, when seeds from which the plants are grown sprout more slowly than the duration of a phase in a cultivation sequence, a user may provide the seeds with more time in the sprouter by placing the seeds in the sprouter earlier in the cultivation sequence. The sprouter 132 may be arranged to support sprouting multiple sets of seeds, with each set placed in the sprouter at different times, so that a set of sprouts may be available in the sprouter for transfer to the grow table as needed.

Further, while, in the description of the initial cultivation sequence 310, certain activities, including those which involve human interaction, are performed on specified days, those activities may be performed on days other than the specified days at the election of the user, so long as the container components, such as lighting elements and grow tray, are arranged to allow access to the necessary plants, supplies, and growing stations.

For example, activities planned for Day i-30, such as plant thinning, may be performed on another day, such as Day i-29 or even Day i-32, or in a different phase. Further, planting may be performed on a date other than the first date of a phase. It may be difficult to plant seedlings in a growing station on a day that is earlier than the scheduled planting day because the growing station may still be disposed under the end panel 174 on the desired planting day and therefore inaccessible or partially obscured, but planting may still occur later than the scheduled date, so long as the seedlings have a sufficient number of days to pass in the growth chamber for adequate plant growth during the remainder of the phase.

As with the initial cultivation sequence 310, while certain activities are described as being performed on selected days of the continuous cultivation sequence 410, the activities may be performed on days other than the specified days at the election of the user, so long as the container components are arranged to allow access to the necessary plants, supplies, and growing stations and so long as a sufficient number of days are allowed in a phase for adequate plant growth.

In certain embodiments, a user may manually move the growing stations relative to the light fixture. In other embodiments, the movement may be motorized, controlled by a timer or automated so as to occur as the plants grow taller and reach a new stage of growth. The plant growing system may be arranged to move the growing stations automatically to maintain the optimal distance between the plants and the lights.

One skilled in the art will appreciate that although only one or two of the components identified above is depicted in the Figures, any number of any of these components may be provided, and that functions provided by one or more components of any of the disclosed systems may be combined or incorporated into one or another component shown in the Figures.

### Advantages

It can be seen that the container gardening structure disclosed here provides many advantages over conventional container gardening structures. For example, disposing lighting elements along the grow tray in increasing distances from the growing plants allows plants growing in an enclosed space to receive customized exposure to light that is optimized for each plant's specific stage of growth. A lighting element at a selected location along the helix of the light fixture may be configured for a selected stage of plant growth the optimal intensity, radiating light of a selected intensity, spectrum and pattern for a selected stage of plant growth, thus improving plant growth and reducing power consumption.

In addition, the container gardening structure here disclosed provides for manual or automatic adjustment of the distance between plants and lights. In addition, the disclosed container gardening structure provides for simplified harvesting, processing & storage of crops, because harvesting, processing and storing one or a few plants at a time is simpler than harvesting, processing and storing an entire crop. Further, frequent production of smaller numbers of individual plants means that, overall, a harvest is stored for a shorter time, increasing freshness of the crop.

The dimensions and capacities of the container components described herein may be left to the designer, and may depend on the size, weight, and number of the desired plants to be grown in the container. The container 100 may be provided with controls for adjusting aspects of the container according to the growing requirements of a selected type of plant. For example, the container may have controls to adjust the height of the lighting fixture relative to the grow tray according to plant type and plant lighting requirements at selected stages of plant growth. In further embodiments, the container 100 may be provided with controls to modify the height of the lighting fixture relative to the grow tray at a selected growing station according to the measured height of the plant in the growing station. The container may also have controls to adjust the intensity of the lighting elements according to the plant type, or controls to adjust the number or width or length of growing stations according to the plant type. Further, controls may be provided to accept a gardener's preferences as to plant types, and, based on the preferences, identify to the gardener the expected maturation period or even recommend a rotation style. In motorized and automatic systems, the controls may customize the rotation style according to the plant type.

In still further embodiments, the grow tray and light fixture both may be stationary, and the movement of the plants relative to the lighting elements may be accomplished by placing plants/seedlings/seeds in growing stations, which may constitute individual growth containers, that are floated around the grow tray at a selected speed. The individual growth containers may be arranged to float stably in the grow tray in the nutrient solution when the depth of the nutrient solution is at a selected height, and to settle stably on the bottom of the grow tray when the depth of the solution is lowered or the solution is removed from the grow tray.

In a floating growing station embodiment, the control systems described for movement of the grow tray and lighting elements in container 100 may be eliminated from the container system; and the nutrient handling system may have an outlet in the grow tray, for example, in the outer rim of the grow tray, so that the nutrient fluid may be pushed in one direction (in one embodiment, clockwise) around the grow tray. In addition, the central column may be connected to the grow tray and be weight-bearing. As a result, the grow tray may effectively constitute an open circular trough in which the individual growth containers are disposed. Further, and the container may be sized to support the growth of plants from seedlings/seeds to fully mature plants ready for harvesting, and to allow the individual growth containers to float stably in the grow tray when the nutrient solution is sufficiently deep in the grow tray, and to settle stably to the bottom of the grow tray when the solution is lowered or removed.

In certain embodiments, the upper section of the individual growth containers may have a cross-section with a width that is sufficiently large to keep the plants (even fully mature plants) in adjacent individual growth containers spaced apart so as to provide a sufficient amount of chamber space for optimal growth of the individual plants, and to shield the nutrient solution in the grow tray from over-exposure of light. In one illustrative but not necessarily preferred embodiment, the upper section cross-section may be round. In other embodiments, the upper section cross-section may be shaped similarly to the grow tray cover 112, in which the individual growth containers openings similar to the size of the multiple openings 114 in the grow tray cover 112. In other embodiments, the spaces on the surface of the grow tray that are not covered by the upper section of the individual growth containers may be filled with floating balls or other buoyant elements to reduce the amount of light that reaches the nutrient solution.

In one stage of an ebb and flow cycle for controlling nutrient fluids in a hydroponic system, the level of the nutrient solution in the grow tray may be made to be deep enough to provide nutrition to the plants but not deep enough to float the plants. The ebb and flow cycle described above may be modified to support a system in which individual growth containers are floated around the grow tray at a selected speed, by providing for extra nutrient solution to be pumped into the grow tray when it is desirable to move the plants in the grow tray. The extra nutrient solution may cause the plants to float, and the circulation pump may push the plants slowly clockwise. Once the plants are moved a desired amount, the nutrient solution system may be operated to lower or remove a selected amount of nutrient solution in order to stop plant movement. Operation of the nutrient solution handing system to raise or lower the level of the solution in the grow tray, to push the individual growth containers along in the grow tray, and to stop the movement of the individual growth containers may be accomplished manually, by operation of a motor, or under computer control. Should operation of the nutrient solution handing system cause the plants to be moved too far along the grow tray, the resultant pressing of the most mature plant against the end panel would stop the movement in the grow tray of the individual growth container holding the most mature plant, which would stop the movement of the individual growth container adjacent thereto, and so on until movement of the grow containers in the grow tray stops. Alternatively, the fluid circulation system may be arranged to operate in reverse.

In other embodiments, the container 100 may also be operated to grow more than one type of plant at a time. For example, a user may identify what types of plants to be grown, and the system could identify which have similar maturation periods or similar expected height/width specifications such that they could be grown together, and the controls may be operated to customize the container to accommodate the gardener's preferences.

The container 100 of the illustrative but not necessarily preferred embodiment shown in FIGS. 1A-1E is intended for operation in normal gravity; however, it can be modified for low- or zero-gravity operation, for installation, for example, in a space station.

Finally, it can be seen that, in embodiments designed for hydroponic gardening, the disclosed container gardening structure is arranged to reduce the volume of the nutrient fluid and the handling to which the nutrient fluid is subjected. Each stage of growth that a plant undergoes has its own consumption needs, with maximum consumption occurring as plants near harvest, and existing gardening containers, in which all plants are at the same stage of growth, must be able to store and pump enough nutrient fluid to support consumption at all stages or growth, including, a fully mature crop. Therefore, the nutrient handling systems of conventional container growing structures, such as pump size and power consumption, are designed to provide the maximum consumption of all of the plants being grown at the same time.

On the other hand, in the container gardening structure herein described, the plants undergo growth in several stages at the same time, so that the needs of the plants at one time range from low to high. Therefore, the nutrient handling systems need to provide only enough fluid to support the average plant size, which is about half that of a full crop. This reduces the amount of nutrient solution that needs to be purchased and stored, as well as reducing the specifications of the structure's nutrient handling system, including pump size and power consumption.

Although the disclosed components have been described above as being separate units, one of ordinary skill in the art will recognize that functionalities provided by one or more units may be combined. As one of ordinary skill in the art will appreciate, one or more units may be optional and may be omitted from implementations in certain embodiments. For example, in one configuration, rotation control or air handling may also be omitted. Further, in other embodiments, cameras, CO2, heating, cooling and humidity control may be omitted.

The foregoing descriptions have been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. It is intended that the specification and examples be considered as exemplary only, with a true scope and spirit of the invention being indicated by the following claims.

1. A gardening structure comprising:
a grow tray having a plurality of growing stations, with the growing stations extending radially from an interior point of the grow tray;
a light fixture having a plurality of lighting elements disposed in space above the grow tray and arranged to radiate light to the grow tray,
wherein the lighting elements have heights associated therewith, a selected height comprising a selected vertical distance from a selected lighting element to the grow tray, the heights monotonically increasing across the light fixture,
from a shortest height between the grow tray and a lowest lighting element,
to a highest height between the grow tray and a highest lighting element, and
wherein a first lighting element is disposed a first height above a first growing station; and
a movement controller for moving the light fixture and the grow stations relative to each other to position the first growing station under a second lighting element that has a greater height from the grow tray than the first height.

2. The gardening structure of claim 1, wherein the lighting elements are arranged in a single turn of a spiral on a helical path on the light fixture around a central axis of the light fixture.

3. The gardening structure of claim 1, further comprising a container sized to hold the grow tray and the light fixture.

4. The gardening structure of claim 3, wherein the container has a reflective inner surface.

5. The gardening structure of claim 1, wherein the interior point comprises a center point of the grow tray.

6. The gardening structure of claim 1, wherein the interior point is disposed a selected distance from a center point of the grow tray.

7. The gardening structure of claim 1, wherein the growing stations are moveable in the grow tray.

8. A method, comprising:
disposing a plurality of plants in different stages of growth in a plurality of growing stations extending radially from an interior point of a grow tray,
wherein the plants in the growth stations are disposed in the grow tray in order from a youngest plant to a most mature plant, and
radiating the plants in the growth stations with light from a light fixture,
wherein the light fixture has a plurality of lighting elements disposed in a space above the grow tray,
wherein the lighting elements have heights associated therewith, a height comprising a vertical distance from a lighting element to the grow tray, the heights increasing for consecutive lighting elements in the light fixture,
from a shortest height between the grow tray and a lowest lighting element,
to a highest height between the grow tray and a highest lighting element; and
wherein a first lighting element is disposed a first height above a first growing station; and
when a selected plant in the first growing station has grown a selected amount, moving the grow tray relative to the light fixture to position the first growing station under a second lighting element that has a greater height from the first growing station than the first height.

9. The method of claim 8, wherein the second lighting element is adjacent to the first lighting element on the light fixture.

10. The method of claim 8, further comprising:
periodically harvesting the plant disposed in the growing station under the highest lighting element,
planting a new seed or new seedlings in an emptied growing station, and
moving the grow tray relative to the light fixture to dispose the newly planted growing station under the lowest lighting element.

11. The method of claim 8,
further comprising extending the lighting elements outwardly from a central axis for the light fixture, the central axis extending orthogonal to the grow tray upward from the grow tray through the interior point of the grow tray, and
wherein moving the grow tray relative to the light fixture further comprises controlling the moving with a movement controller for moving the light fixture and the grow stations relative to each other.

12. The method of claim 8, wherein moving the grow tray relative to the light fixture further comprises rotating the light fixture around the grow tray.

13. The method of claim 12, wherein the grow tray is stationary.

14. The method of claim 12, further comprises rotating the grow tray.

15. The method of claim 8, wherein moving the grow tray relative to the light fixture further comprises rotating the grow tray around the light fixture.

16. The method of claim 15, wherein the light fixture is stationary.

17. The method of claim 10, further comprising arranging the lighting elements on the light fixture in a single turn of a spiral of a helical path around a central axis of the light fixture.

18. The method of claim 8, further comprising enclosing the grow tray and the light fixture in a container.

19. The method of claim 8, wherein the interior point is offset from a center point of the grow tray.

20. A system comprising:
a grow tray having a plurality of growing stations, with the growing stations arranged to hold a plurality of plants and to support growth thereof, and with the growing stations extending a radial distance from an interior point of the grow tray;
a light fixture having a plurality of lighting elements disposed in space above the grow tray and arranged to radiate light to the grow tray,
wherein the lighting elements extend outwardly from a central axis for the light fixture, the central axis extending orthogonal to the grow tray upward from the grow tray through the interior point of the grow tray, and
wherein the plurality of lighting elements is arranged along the light fixture such that a vertical distance from lighting elements to the grow tray increases from a lowest lighting element to a highest lighting element fixture; and
a movement controller for moving the light fixture and the grow stations relative to each other such that a first growing station that had been positioned under a first lighting element is positioned under a second lighting element that has a greater distance from the grow tray than the first lighting element.

21. The system of claim 20, wherein the lighting elements comprise lighting panels that are joinable with adjacent lighting panels.

22. The system of claim 21, wherein at least one lighting element is formed of a single lighting panel.

23. The system of claim 21, wherein at least one lighting element is formed of a plurality of lighting panels joined together.

24. The system of claim 23, wherein the desired lighting configuration further comprises at least one selected lighting element formed of a single lighting panel.

25. The system of claim 21, wherein the lighting panels are modular components.

26. The system of claim 21, wherein the lighting panels are uniform in shape and construction.

27. The system of claim 21, further comprising a container sized to hold the grow tray and the light fixture,
wherein the container has a central column along an axis extending orthogonal to the grow tray, upward in the container, and in, on, or from which the light fixture may be disposed, and
wherein the light fixture further has a selected lighting panel with:
a bottom surface for holding downwardly facing lights,
a first side edge and a second side edge, the first side edge and the second side edge extending outwardly along the selected lighting panel from inner vertices to outer vertices, and
a ring bracket disposed at or near the inner vertices,
wherein the ring bracket is sized to fit over the central column and to stack with other ring brackets of other lighting panels on the central column, and
wherein the ring bracket is further arranged to stably support the downwardly facing lights on the selected lighting panel in position over the grow tray when the ring bracket is fit over the central column.

28. The system of claim 27, wherein the selected lighting panel has generally a shape of a sector.

29. The system of claim 20, wherein the lighting elements are arranged to be spread out in a pattern along the central axis for the light fixture to form a single turn of a helical path of the lighting elements disposed around the central axis.

30. The system of claim 29,
wherein the first lighting element and the second lighting element are consecutively disposed and adjacent on the light fixture, and
wherein a top edge of the one side of the first lighting element is arranged to abut a bottom edge of the other side of the second lighting element.

31. The system of claim 20, further comprising:
a container sized to hold the grow tray and the light fixture, and
an equipment bay disposed in the space of the container above the lighting elements and sized to house equipment for use in maintaining the plants.

32. The system of claim 20,
wherein the system is arranged to employ a hydroponic growth technique, and
further comprising a nutrient handling system arranged to transfer and circulate nutrients through the growing stations of the grow tray.
